(19) United States
(12) Patent Application Publication
(10) Pub. No.: US 2025/0324463 A1
(43) Pub. Date: Oct. 16, 2025

(54) CROSS-SSB-SUPPORTING MULTI-PRACH TRANSMISSION CONFIGURATION METHODS AND APPARATUSES

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 18/867,967

(22) PCT Filed: May 23, 2022
(86) PCT No.: PCT/CN2022/094572

§ 371 Date: Nov. 21, 2024

(51) Int. Cl. H04W 74/0838

(52) U.S. Cl. CPC H04W 74/0838

(57) ABSTRACT

The present disclosure belongs to the technical field of communications, Provided are cross-SSB-supporting multi-PRACH transmission configuration methods and apparatuses, and a device and a storage medium. A cross-SSB-supporting multi-PRACH transmission configuration method includes: sending a multi-PRACH transmission configuration to a terminal device, wherein the multi-PRACH transmission configuration is used for indicating an SSB usage mode corresponding to PRACH resources, which are used by the terminal device to send a plurality of PRACH transmissions according to the multi-PRACH transmission configuration; and receiving a plurality of PRACHs, which are transmitted on the PRACH resources by the terminal device by means of the SSB usage mode.

### CROSS-REFERENCE

The present application is a U.S. National Stage of International Application No. PCT/CN2022/094572, filed on May 23, 2022, the contents of which are incorporated herein by reference in its entirety for all purposes.

### TECHNICAL FIELD

The present disclosure relates to the field of communication technologies, and in particular to a method and apparatus for supporting a multi-Physical Random Access Channel (PRACH) transmission configuration across Synchronization Signal Blocks (SSBs), a device and a storage medium

### BACKGROUND

In communication systems, poor uplink coverage would affect the communication quality between terminal devices and network side devices. One of factors affecting the uplink coverage is a Physical Random Access Channel (PRACH) channel.

### SUMMARY

The present disclosure provides a method and apparatus for supporting a multi-PRACH transmission configuration across SSBs, a device, and a storage medium.

An aspect of embodiments of the present disclosure provides a method for supporting a multi-Physical Random Access Channel (PRACH) transmission configuration across Synchronization Signal Blocks (SSBs). The method is performed by a network side, device, and includes:
sending a multi-PRACH transmission configuration to a terminal device, wherein the multi-PRACH transmission configuration is configured to indicate a SSB usage mode corresponding to a PRACH resource used by the terminal device to send, according to the multi-PRACH transmission configuration, a plurality of PRACH transmissions; and
receiving a plurality of PRACHs which are transmitted on the PRACH resource by the terminal device through the SSB usage mode.

Another aspect of embodiments of the present disclosure provides a method for supporting a multi-PRACH transmission configuration across SSBs. The method is performed by a terminal device, and includes:
transmitting to a network side device a plurality of PRACHs on a PRACH resource through a SSB usage mode.

Still another aspect of embodiments of the present disclosure provides a terminal device, including a processor and a memory, wherein a computer program is stored in the memory, and the processor executes the computer program stored in the memory to cause the communication device to execute the method provided in the aspect of the above embodiments.

Still another aspect of embodiments of the present disclosure provides a network side device, including a processor and a memory, wherein a computer program is stored in the memory, and the processor executes the computer program stored in the memory to cause the communication device to execute the method provided in the other aspect of the above embodiments.

### BRIEF DESCRIPTION OF THE DRAWINGS

The above and/or additional aspects and advantages of the present disclosure will become apparent and readily understood from the following description of embodiments with reference to the accompanying drawings, in which:

FIG. 1 is a schematic flowchart of a method for supporting a multi-PRACH transmission configuration across SSBs provided by an embodiment of the present disclosure;

FIG. 2 is a schematic flowchart of a method for supporting a multi-PRACH transmission configuration across SSBs provided by another embodiment of the present disclosure;

FIG. 3 is a schematic flowchart of a method for supporting a multi-PRACH transmission configuration across SSBs provided by yet another embodiment of the present disclosure;

FIG. 4 is a schematic flowchart of a method for supporting a multi-PRACH transmission configuration across SSBs provided by still another embodiment of the present disclosure;

FIG. 5 is a schematic flowchart of a method for supporting a multi-PRACH transmission configuration across SSBs provided by still another embodiment of the present disclosure;

FIG. 6 is a schematic flowchart of a method for supporting a multi-PRACH transmission configuration across SSBs provided by still another embodiment of the present disclosure;

FIG. 7 is a schematic flowchart of a method for supporting a multi-PRACH transmission configuration across SSBs provided by still another embodiment of the present disclosure;

FIG. 8 is a schematic flowchart of a method for supporting a multi-PRACH transmission configuration across SSBs provided by still another embodiment of the present disclosure;

FIG. 9 is a schematic flowchart of a method for supporting a multi-PRACH transmission configuration across SSBs provided by still another embodiment of the present disclosure;

FIG. 10 is a schematic flowchart of a method for supporting a multi-PRACH transmission configuration across SSBs provided by still another embodiment of the present disclosure;

FIG. 11 is a schematic flowchart of a method for supporting a multi-PRACH transmission configuration across SSBs provided by still another embodiment of the present disclosure;

FIG. 12 is a schematic flowchart of a method for supporting a multi-PRACH transmission configuration across SSBs provided by still another embodiment of the present disclosure;

FIG. 13 is a schematic flowchart of a method for supporting a multi-PRACH transmission configuration across SSBs provided by still another embodiment of the present disclosure;

FIG. 14 is a schematic flowchart of a method for supporting a multi-PRACH transmission configuration across SSBs provided by still another embodiment of the present disclosure;

FIG. 15 is a schematic flowchart of a method for supporting a multi-PRACH transmission configuration across SSBs provided by still another embodiment of the present disclosure;

FIG. 16 is a schematic structural diagram of an apparatus for supporting a multi-PRACH transmission configuration across SSBs provided by an embodiment of the present disclosure;

FIG. 17 is a schematic structural diagram of an apparatus for supporting a multi-PRACH transmission configuration across SSBs provided by another embodiment of the present disclosure;

FIG. 18 is a block diagram of a terminal device provided by an embodiment of the present disclosure; and

FIG. 19 is a block diagram of a network side device provided by an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the embodiments of the present disclosure. Instead, they are merely examples of apparatuses and methods consistent with some aspects of embodiments of the present disclosure as recited in the appended claims.

The terms used in embodiments of the present disclosure are merely for the purpose of describing particular embodiments and are not intended to limit embodiments of the present disclosure. As used in embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, the first indication information may also be referred to as the second information, and similarly, the second information may also be referred to as the first information. Depending on the context, the word “if” as used herein can be interpreted as “upon” or “when” or “in response to determination”.

The network element involved in embodiments of the present disclosure may be a network function, which may be implemented by independent hardware devices or by software in the hardware devices, which is not limited in embodiments of the present disclosure.

As described above, the communication systems, poor uplink coverage would affect the communication quality between terminal devices and network side devices. One of factors affecting the uplink coverage is a PRACH channel. The terminal device can only send one Msg1 transmission in one random access attempt, without involving multi-PRACH transmission, resulting in poor coverage of the PRACH channel. Therefore, there is an urgent need for a “multi-PRACH transmission configuration” method, so as to enable the terminal device to transmit, through a SSB usage mode, multiple PRACHs on PRACH resources, thereby improving the coverage of the PRACH channel.

A method and apparatus for supporting a multi-PRACH transmission configuration across SSBs, a device and a storage medium provided by embodiments of the present disclosure are described in details below with reference to the accompanying drawings.

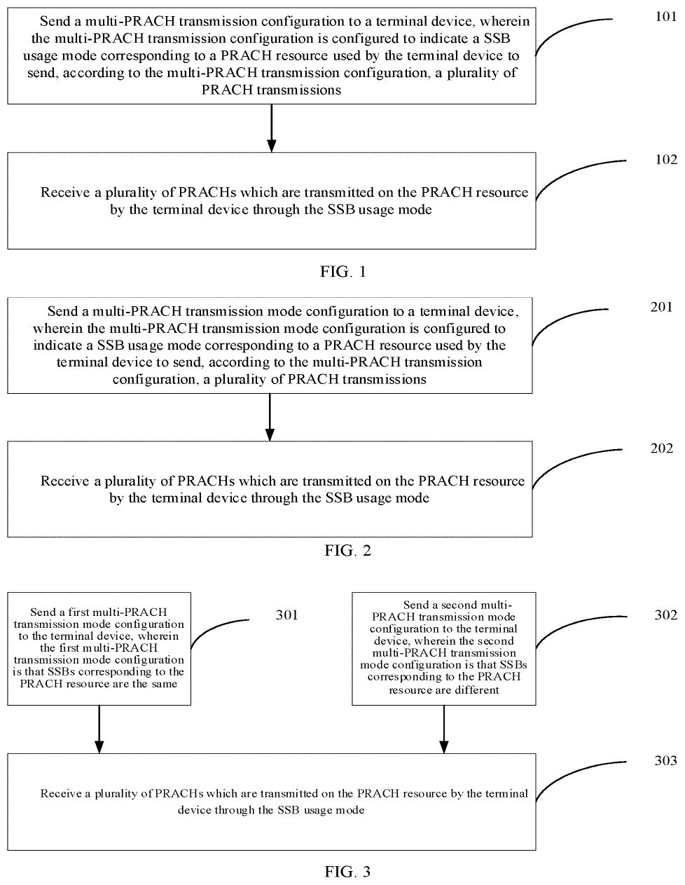

FIG. 1 is a schematic flowchart of a method for supporting a multi-PRACH transmission configuration across SSBs provided by an embodiment of the present disclosure. The method is performed by a network side device. As shown in FIG. 1, the method may include steps 101 to 102.

In the step 101, a multi-PRACH transmission configuration is sent to a terminal device, and the multi-PRACH transmission configuration is configured to indicate a SSB usage mode corresponding to a PRACH resource used by the terminal device to send, according to the multi-PRACH transmission configuration, a plurality of PRACH transmissions.

In the step 102, a plurality of PRACHs transmitted on the PRACH resource by the terminal device through the SSB usage mode are received.

It should be noted that in an embodiment of the present disclosure, the terminal device may refer to a device that provides speech and/or data connectivity for a user. The terminal device may communicate with one or more core networks via a Radio Access Network (RAN), The terminal device may be an Internet of Things terminal, such as a sensor device, a mobile phone (or a “cellular” phone), and a computer having an Internet of Things terminal, for example, a fixed, portable, pocket-sized, handheld, computer built-in or vehicle-mounted device. For example, it may be a station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the terminal device may also be an in-vehicle device, for example, a trip computer with a wireless communication function, or a wireless terminal external to the trip computer. Alternatively, the terminal device may also be a roadside device, for example, a street light, a signal light, or other roadside device with a wireless communication function, etc.

In an embodiment of the present disclosure, when the terminal device sends a preamble, for example, it can perform the preamble time domain repetition, that is, it continuously sends multiple preambles in the time domain. One PRACH transmission refers to continuously transmitting multiple preambles as a whole, and the multi-PRACH transmission refers to multiple PRACH transmissions.

In an embodiment of the present disclosure, sending the multi-PRACH transmission configuration to the terminal device includes:
sending a multi-PRACH transmission mode configuration to the terminal device.

In an embodiment of the present disclosure, sending the multi-PRACH transmission mode configuration to the terminal device includes at least one of:
sending a first multi-PRACH transmission mode configuration to the terminal device, wherein the first multi-PRACH transmission mode configuration is that SSBs corresponding to the PRACH resource are the same; or
sending a second multi-PRACH transmission mode configuration to the terminal device, wherein the second multi-PRACH transmission mode configuration is that SSBs corresponding to the PRACH resource are different.

In an embodiment of the present disclosure, sending the first multi-PRACH transmission mode configuration to the terminal device includes at least one of:
sending to the terminal device a first multi-PRACH transmission mode configuration in which cross-SSB is allowed; or
sending to the terminal device a first multi-PRACH transmission mode configuration in which the cross-SSB is not allowed.

In an embodiment of the present disclosure, sending the second multi-PRACH transmission mode configuration to the terminal device includes at least one of
sending to the terminal device a second multi-PRACH transmission mode configuration in which an SSB gap between PRACH transmissions is allowed; or
sending to the terminal device a second multi-PRACH transmission mode configuration in which the SSB gap between the PRACH transmissions is not allowed.

For example, in an embodiment of the present disclosure, sending the multi-PRACH transmission configuration to the terminal device includes at least one of:
sending the multi-PRACH transmission configuration to the terminal device, wherein the multi-PRACH transmission configuration includes a first multi-PRACH transmission configuration based on a Contention-Free Random Access (CFRA) and a second multi-PRACH transmission configuration based on a Contention-Based Random Access (CBRA).

Further, in an embodiment of the present disclosure, a trigger mode of the CFRA includes at least one of.
a Physical Downlink Control Channel (PDCCH) trigger mode;
a handover trigger mode;
a beam failure recovery trigger mode; or
a PScell addition or change trigger mode.

In an embodiment of the present disclosure, sending the multi-PRACH transmission configuration to the terminal device includes:
in response to a CFRA triggered by a PDCCH, sending a PDCCH order to the terminal device, wherein the first multi-PRACH transmission configuration is carried in the PDCCH order.

In an embodiment of the present disclosure, sending the multi-PRACH transmission configuration to the terminal device includes:

in response to a CFRA triggered by Pscell addition or change, sending RACH-ConfigDedicated to the terminal device, wherein the first multi-PRACH transmission configuration is carried in a CFRA configuration of the RACH-ConfigDedicated.

In an embodiment of the present disclosure, sending the multi-PRACH transmission configuration to the terminal device includes:

in response to a CFRA triggered by a handover, sending RACH-ConfigDedicated to the terminal device, wherein the first multi-PRACH transmission configuration is carried in a CFRA configuration of the RACH-ConfigDedicated.

In an embodiment of the present disclosure, sending the multi-PRACH transmission configuration to the terminal device includes:
in response to a CFRA triggered by a beam failure recovery, sending BeamFailureRecoveryConfig to the terminal device, wherein the first multi-PRACH transmission configuration is carried in the BeamFailureRecoveryConfig.

In an embodiment of the present disclosure, sending the multi-PRACH transmission configuration to the terminal device includes:
sending the second multi-PRACH transmission configuration to the terminal device through a broadcast signaling or through a dedicated signaling.

In an embodiment of the present disclosure, the broadcast signaling includes System Message Block 1 (SIB1).

In an embodiment of the present disclosure, the dedicated signaling includes at least one of:
a Radio Resource Control (RRC) Reconfiguration message;
a RRCResume message;
a RRCRelease message; or
a RRCSetup message.

In an embodiment of the present disclosure, sending the multi-PRACH transmission configuration to the terminal device includes:
sending a common Random Access Channel (RACH) configuration to the terminal device, wherein the second multi-PRACH transmission configuration is carried in the RACH configuration.

In an embodiment of the present disclosure, the RACH configuration includes common RACH resources separately configured on individual Bandwidth Parts (BWPs).

In an embodiment of the present disclosure, sending the RACH configuration to the terminal device includes:
sending first RACH-ConfigCommon in an initial BWP configuration of SIB1 to the terminal device, wherein the RACH configuration is carried in the first RACH-ConfigCommon.

In an embodiment of the present disclosure, sending the RACH configuration to the terminal device includes:
sending second RACH-ConfigCommon of a BWP configuration of the RRCReconfiguration message to the terminal device, wherein the RACH configuration is carried in the second RACH-ConfigCommon.

In an embodiment of the present disclosure, sending the multi-PRACH transmission configuration to the terminal device includes:
sending a dedicated RACH configuration to the terminal device, wherein the second multi-PRACH transmission configuration is carried in the dedicated RACH configuration.

In an embodiment of the present disclosure, sending the dedicated RACH configuration to the terminal device includes:
in response to a CBRA triggered by a beam failure recovery, sending BeamFailureRecoveryConfig to the terminal device, wherein the second multi-PRACH transmission configuration configured in the dedicated RACH configuration is carried in the BeamFailureRecoveryConfig.

In an embodiment of the present disclosure, sending the multi-PRACH transmission configuration to the terminal device includes:
in response to a CBRA triggered by Pscell addition or change, sending RACH-ConfigDedicated to the terminal device, wherein the second multi-PRACH transmission configuration configured in the dedicated RACH configuration is carried in the RACH-ConfigDedicated,
In an embodiment of the present disclosure, sending the multi-PRACH transmission configuration to the terminal device includes:
in response to a CBRA triggered by a handover, sending RACH-ConfigDedicated to the terminal device, wherein the second multi-PRACH transmission configuration configured in the dedicated RACH configuration is carried in the RACH-ConfigDedicated.

In an embodiment of the present disclosure, sending the multi-PRACH transmission configuration to the terminal device includes:
sending a RACH configuration of a feature combination to the terminal device, wherein the second multi-PRACH transmission configuration is carried in the RACH configuration of the feature combination.

In an embodiment of the present disclosure, the feature combination includes a Coverage Enhancement feature, and the Coverage Enhancement feature is configured to indicate a Coverage Enhancement feature that supports a second multi-PRACH transmission.

In an embodiment of the present disclosure, the method further includes:
receiving PRACH capability information sent by the terminal device, wherein the PRACH capability information is configured to indicate capability information of the terminal device supporting multi-PRACH transmission.

In an embodiment of the present disclosure, receiving the PRACH capability information sent by the terminal device includes:
receiving UECapabilityInformation sent by the terminal device, wherein the PRACH capability information is carried in the UECapability Information.

In an embodiment of the present disclosure, the PRACH capability information includes at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

In an embodiment of the present disclosure, after receiving the PRACH capability information sent by the terminal device, the method further includes:
based on the PRACH capability information, configuring a multi-PRACH transmission mode configuration for the terminal device through a dedicated signaling.

In summary, in the embodiments of the present disclosure, the multi-PRACH transmission configuration is sent to the terminal device, and the multi-PRACH transmission configuration is configured to indicate the SSB usage mode corresponding to the PRACH resource used by the terminal device to send, according to the multi-PRACH transmission configuration, the plurality of PRACH transmissions; and the plurality of PRACHs transmitted on the PRACH resource by the terminal device through the SSB usage mode are received. In the embodiments of the present disclosure, the terminal device can transmit the plurality of PRACHs on the PRACH resource through the SSB usage mode, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 2 is a schematic flowchart of a method for supporting a multi-PRACH transmission configuration across SSBs provided by an embodiment of the present disclosure. The method is performed by a network side device. As shown in FIG. 2, the method may include steps 201 to 202.

In the step 201, a multi-PRACH transmission mode configuration is sent to a terminal device, and the multi-PRACH transmission mode configuration is configured to indicate a SSB usage mode corresponding to a PRACH resource used by the terminal device to send, according to the multi-PRACH transmission configuration, a plurality of PRACH transmissions.

In the step 202, a plurality of PRACHs transmitted on the PRACH resource by the terminal device through the SSB usage mode are received.

In summary, in the embodiments of the present disclosure, the multi-PRACH transmission configuration is sent to the terminal device, and the multi-PRACH transmission configuration is configured to indicate the SSB usage mode corresponding to the PRACH resource used by the terminal device to send, according to the multi-PRACH transmission configuration, the plurality of PRACH transmissions; and the plurality of PRACHs transmitted on the PRACH resource by the terminal device through the SSB usage mode are received. In the embodiments of the present disclosure, the terminal device can transmit the plurality of PRACHs on the PRACH resource through the SSB usage mode, thereby reducing the situation where the plurality of PRACHs cannot be transmitted, and improving the probability of successful random access. The embodiments of the present disclosure specifically disclose that the multi-PRACH transmission configuration is the multi-PRACH transmission mode configuration. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 3 is a schematic flowchart of a method for supporting a multi-PRACH transmission configuration across SSBs provided by an embodiment of the present disclosure. The method is performed by a network side device. As shown in FIG. 3, the method may include steps 301 to 303, where one of the steps 301 and 302 is performed.

In the step 301, a first multi-PRACH transmission mode configuration is sent to a terminal device, and the first multi-PRACH transmission mode configuration is that SSBs corresponding to the PRACH resource are the same.

In an embodiment of the present disclosure, the first multi-PRACH transmission mode configuration refers to a multi-PRACH transmission mode configuration in which SSBs corresponding to the PRACH resource are the same. The first in the first multi-PRACH transmission mode configuration is only used to distinguish from other multi-PRACH transmission mode configurations, and does not specifically refer to a fixed multi-PRACH transmission mode configuration. For example, when the SSB corresponding to the first multi-PRACH transmission mode configuration changes, the first multi-PRACH transmission mode configuration may also change accordingly.

In an embodiment of the present disclosure, sending, by the network side device, the first multi-PRACH transmission mode configuration to the terminal device, includes at least one of:
sending to the terminal device a first multi-PRACH transmission mode configuration in which cross-SSB is allowed; or
sending to the terminal device a first multi-PRACH transmission mode configuration in which the cross-SSB is not allowed.

For example, in an embodiment of the present disclosure, when the SSB includes SSB1, SSB2, SSB3, and SSB4, there are Random access Opportunities (ROs) RO1 and RO2 in SSB1, and the first multi-PRACH transmission mode configuration in which the cross-SSB is allowed may be, for example, configured to indicate the terminal device to transmit multiple PRACHs through RO1 and RO2 in SSB1, If the total number of PRACH transmissions is less than a configured value N, and there are no remaining ROs in SSB1, the terminal device can send the remaining number of PRACH transmissions in a RO associated with the next transmission time of SSB1.

For example, in an embodiment of the present disclosure, when the SSB includes SSB1, SSB2, SSB3 and SSB4, there are RO1 and RO2 in SSB1, and the first multi-PRACH transmission mode configuration in which the cross-SSB is not allowed may be, for example, configured to indicate that after the terminal device transmits the multiple PRACHs through RO1 and RO2 in SSB1, if the total number of PRACH transmissions is less than the configured value N, and there are no remaining ROs in SSB1, the terminal device no longer sends the remaining number of the multiple PRACHs

In the step 302, a second multi-PRACH transmission mode configuration is sent to the terminal device, and the second multi-PRACH transmission mode configuration is that SSBs corresponding to the PRACH resource are different.

For example, in an embodiment of the present disclosure, when SSB includes SSB1, SSB2, SSB3 and SSB4, there are RO1 and RO2 in SSB1, and there are RO3 and RO4 in SSB2, and the second multi-PRACH transmission mode configuration may be for example that the terminal device can transmit multiple PRACHs through RO1 in SSB1 and RO3 in SSB2.

In an embodiment of the present disclosure, sending, by the network side device, the second multi-PRACH transmission mode configuration to the terminal device, includes at least one of:

sending to the terminal device a second multi-PRACH transmission mode configuration in which an SSB gap between PRACH transmissions is allowed; or

sending to the terminal device a second multi-PRACH transmission mode configuration in which the SSB gap between the PRACH transmissions is not allowed.

In the step S303, a plurality of PRACHs transmitted on the PRACH resource by the terminal device through the SSB usage mode are received.

In summary, in the embodiments of the present disclosure, the first multi-PRACH transmission mode configuration is sent to the terminal device, and the first multi-PRACH transmission mode configuration is that the SSBs corresponding to the PRACH resource are the same; the second multi-PRACH transmission mode configuration is sent to the terminal device, and the second multi-PRACH transmission mode configuration is that the SSBs corresponding to the PRACH resource are different; and the plurality of PRACHs transmitted on the PRACH resource by the terminal device through the SSB usage mode are received. In the embodiments of the present disclosure, the terminal device can transmit the plurality of PRACHs on the PRACH resource through the SSB usage mode, thereby reducing the situation where the plurality of PRACHs cannot be transmitted, and improving the probability of successful random access. The embodiments of the present disclosure specifically disclose that the multi-PRACH transmission mode configuration includes the first multi-PRACH transmission mode configuration and the second multi-PRACH transmission mode configuration. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

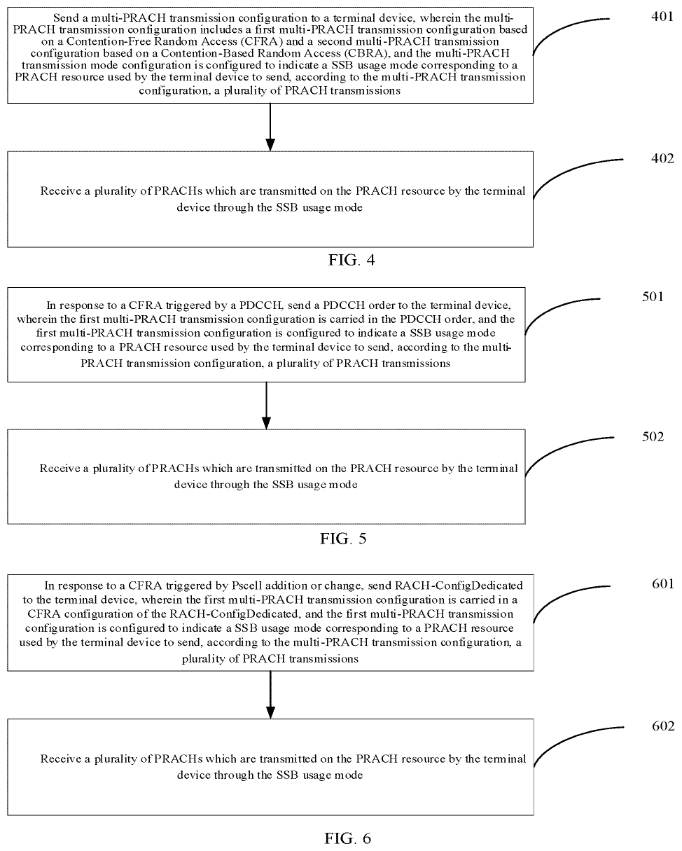

FIG. 4 is a schematic flowchart of a method for supporting a multi-PRACH transmission configuration across SSBs provided by an embodiment of the present disclosure. The method is performed by a network side device. As shown in FIG. 4, the method may include steps 401 and 402.

In the step 401, a multi-PRACH transmission configuration is sent to a terminal device, the multi-PRACH transmission configuration includes a first multi-PRACH transmission configuration based on a Contention-Free Random Access (CFRA) and a second multi-PRACH transmission configuration based on a Contention-Based Random Access (CBRA), and the multi-PRACH transmission configuration is configured to indicate a SSB usage mode corresponding to a PRACH resource used by the terminal device to send, according to the multi-PRACH transmission configuration, a plurality of PRACH transmissions.

In the step 402, a plurality of PRACHs transmitted on the PRACH resource by the terminal device through the SSB usage mode are received.

In an embodiment of the present disclosure, a trigger mode of the CFRA includes at least one of:
a Physical Downlink Control Channel (PDCCH) trigger mode;
a handover trigger mode;
a beam failure recovery trigger mode; or
a PScell addition or change trigger mode.

Furthermore, in an embodiment of the present disclosure, the first multi-PRACH transmission configuration refers to a multi-PRACH transmission configuration based on the CFRA, and the second multi-PRACH transmission configuration refers to a multi-PRACH transmission configuration based on the CBRA. The first and the second are only used to distinguish the differences in the multi-PRACH transmission configurations, and the first multi-PRACH transmission configuration and the second multi-PRACH transmission configuration do not specifically refer to a fixed multi-PRACH transmission configuration.

In summary, in the embodiments of the present disclosure, the multi-PRACH transmission configuration is sent to the terminal device, the multi-PRACH transmission configuration includes the first multi-PRACH transmission configuration based on the CFRA and the second multi-PRACH transmission configuration based on the CBRA, and the multi-PRACH transmission configuration is configured to indicate the SSB usage mode corresponding to the PRACH resource used by the terminal device to send, according to the multi-PRACH transmission configuration, the plurality of PRACH transmissions; and the plurality of PRACHs transmitted on the PRACH resource by the terminal device through the SSB usage mode are received. In the embodiments of the present disclosure, the terminal device can transmit the plurality of PRACHs on the PRACH resource through the SSB usage mode indicated by the multi-PRACH transmission configuration sent by the network side device, thereby reducing the situation where the plurality of PRACHs cannot be transmitted, and improving the probability of successful random access. The embodiments of the present disclosure specifically disclose that the multi-PRACH transmission configuration includes the first multi-PRACH transmission configuration based on the CFRA and the second multi-PRACH transmission configuration based on the CBRA. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 5 is a schematic flowchart of a method for supporting a multi-PRACH transmission configuration across SSBs provided by an embodiment of the present disclosure. The method is performed by a network side device. As shown in FIG. 5, the method may include steps 501 and 502.

In the step 501, in response to a CFRA triggered by a PDCCH, a PDCCH order is sent to a terminal device, a first multi-PRACH transmission configuration is carried in the PDCCH order, and the first multi-PRACH transmission configuration is configured to indicate a SSB usage mode corresponding to a PRACH resource used by the terminal device to send, according to the multi-PRACH transmission configuration, a plurality of PRACH transmissions.

In the step 502, a plurality of PRACHs transmitted on the PRACH resource by the terminal device through the SSB usage mode are received.

In an embodiment of the present disclosure, a trigger mode of the CFRA includes at least one of:
a Physical Downlink Control Channel (PDCCH) trigger mode;
a handover trigger mode;
a beam failure recovery trigger mode; or
a PScell addition or change trigger mode.

For example, in an embodiment of the present disclosure, when the trigger mode of the CFRA is the PDCCH trigger mode, in response to the CFRA triggered by the PDCCH, the network side device may send the PDCCH order to the terminal device. Since the PDCCH order carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions, the terminal device may transmit the multiple PRACHs on the PRACH resource according to the SSB usage mode, and the network side device can receive the multiple PRACHs transmitted by the terminal device on the PRACH resources through the SSB usage mode.

In summary, in the embodiments of the present disclosure, in response to the CFRA triggered by the PDCCH, the PDCCH order is sent to the terminal device, the first multi-PRACH transmission configuration is carried in the PDCCH order, and the first multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that in response to the CFRA triggered by the PDCCH, the network side device may send the PDCCH order to the terminal device to send the first multi-PRACH transmission configuration to the terminal device, which can improve the accuracy of sending the first multi-PRACH transmission configuration. In the embodiments of the present disclosure, the terminal device can transmit the multiple PRACHs on the PRACH resource through the SSB usage mode indicated by the first multi-PRACH transmission configuration sent by the network side device, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 6 is a schematic flowchart of a method for supporting a multi-PRACH transmission configuration across SSBs provided by an embodiment of the present disclosure. The method is performed by a network side device. As shown in FIG. 6, the method may include steps 601 and 602.

In the step 601, in response to a CFRA triggered by Pscell addition or change, RACH-ConfigDedicated is sent to a terminal device, a first multi-PRACH transmission configuration is carried in a CFRA configuration of the RACH-ConfigDedicated, and the first multi-PRACH transmission configuration is configured to indicate a SSB usage mode corresponding to a PRACH resource used by the terminal device to send, according to the multi-PRACH transmission configuration, a plurality of PRACH transmissions.

In the step 602, a plurality of PRACHs transmitted on the PRACH resource by the terminal device through the SSB usage mode are received.

In an embodiment of the present disclosure, a trigger mode of the CFRA includes at least one of:
a Physical Downlink Control Channel (PDCCH) trigger mode;
a handover trigger mode;
a beam failure recovery trigger mode; or
a PScell addition or change trigger mode.

For example, in an embodiment of the present disclosure, when the trigger mode of CFRA is the PScell addition or change trigger mode, in response to the CFRA triggered by the PScell addition or change, the network side device can send the RACH-ConfigDedicated to the terminal device. Since the RACH-ConfigDedicated carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions, the terminal device may transmit the multiple PRACHs on the PRACH resource according to the SSB usage mode, and the network side device can receive the multiple PRACHs transmitted by the terminal device on the PRACH resources through the SSB usage mode.

In summary, in the embodiments of the present disclosure, in response to the CFRA triggered by the PScell addition or change, the RACH-ConfigDedicated is sent to the terminal device, the CFRA configuration of the RACH-ConfigDedicated carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that in response to the CFRA triggered by the PScell addition or change, the network side device can send the RACH-ConfigDedicated to the terminal device to send the first multi-PRACH transmission configuration to the terminal device, which can improve the accuracy of sending the first multi-PRACH transmission configuration. In the embodiments of the present disclosure, the terminal device can transmit the multiple PRACHs on the PRACH resource through the SSB usage mode indicated by the first multi-PRACH transmission configuration sent by the network side device, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

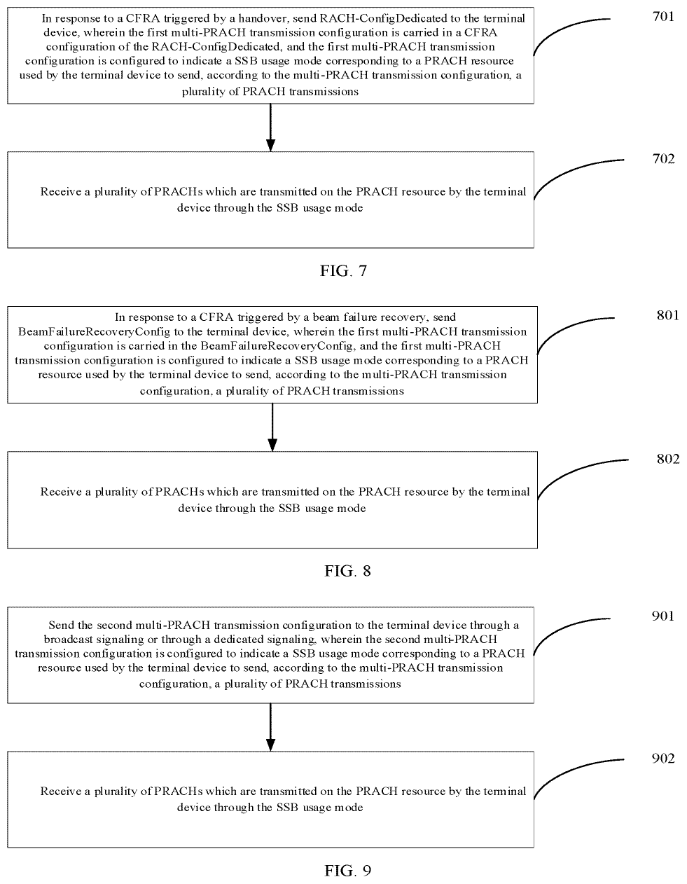

FIG. 7 is a schematic flowchart of a method for supporting a multi-PRACH transmission configuration across SSBs provided by an embodiment of the present disclosure. The method is performed by a network side device. As shown FIG. 7, the method may include steps 701 and 702.

In the step 701, in response to a CFRA triggered by a handover, RACH-ConfigDedicated is sent to a terminal device, a first multi-PRACH transmission configuration is carried in a CFRA configuration of the RACH-ConfigDedicated, and the first multi-PRACH transmission configuration is configured to indicate a SSB usage mode corresponding to a PRACH resource used by the terminal device to send, according to the multi-PRACH transmission configuration, a plurality of PRACH transmissions.

In the step 702, a plurality of PRACHs transmitted on the PRACH resource by the terminal device through the SSB usage mode are received.

In an embodiment of the present disclosure, a trigger mode of the CFRA includes at least one of:
a Physical Downlink Control Channel (PDCCH) trigger mode;
a handover trigger mode;
a beam failure recovery trigger mode; or
a PScell addition or change trigger mode.

For example, in an embodiment of the present disclosure, when the trigger mode of the CFRA is the handover trigger mode, in response to the CFRA triggered by the handover, the network side device can send the RACH-ConfigDedicated to the terminal device. Since the RACH-ConfigDedicated carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions, the terminal device may transmit the multiple PRACHs on the PRACH resource according to the SSB usage mode, and the network side device can receive the multiple PRACHs transmitted by the terminal device on the PRACH resources through the SSB usage mode.

In summary, in the embodiments of the present disclosure, in response to the CFRA triggered by the handover, the RACH-ConfigDedicated is sent to the terminal device, the CFRA configuration of the RACH-ConfigDedicated carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that in response to the CFRA triggered by the handover, the network side device can send the RACH-ConfigDedicated to the terminal device to send the first multi-PRACH transmission configuration to the terminal device, which can improve the accuracy of sending the first multi-PRACH transmission configuration. In the embodiments of the present disclosure, the terminal device can transmit the multiple PRACHs on the PRACH resource through the SSB usage mode indicated by the first multi-PRACH transmission configuration sent by the network side device, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 8 is a schematic flowchart of a method for supporting a multi-PRACH transmission configuration across SSBs provided by an embodiment of the present disclosure. The method is performed by a network side device. As shown FIG. 8, the method may include steps 801 and 802.

In the step 801, in response to a CFRA triggered by a beam failure recovery, BeamFailureRecoveryConfig is sent to the terminal device, a first multi-PRACH transmission configuration is carried in the BeamFailureRecoveryConfig, and the first multi-PRACH transmission configuration is configured to indicate a SSB usage mode corresponding to a PRACH resource used by the terminal device to send, according to the multi-PRACH transmission configuration, a plurality of PRACH transmissions.

In the step 802, a plurality of PRACHs transmitted on the PRACH resource by the terminal device through the SSB usage mode are received.

For example, in an embodiment of the present disclosure, when the trigger mode of the CFRA is the beam failure recovery trigger mode, in response to the CFRA triggered by the beam failure recovery, the network side device can send the BeamFailureRecoveryConfig to the terminal device. Since the BeamFailureRecoveryConfig carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions, the terminal device may transmit the multiple PRACHs on the PRACH resource according to the SSB usage mode, and the network side device can receive the multiple PRACHs transmitted by the terminal device on the PRACH resources through the SSB usage mode.

In summary, in the embodiments of the present disclosure, in response to the CFRA triggered by the beam failure recovery, the BeamFailureRecoveryConfig is sent to the terminal device, the CFRA configuration of the BeamFailureRecoveryConfig carries the first multi-PRACH transmission configuration, and the first multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that in response to the CFRA triggered by the beam failure recovery, the network side device can send the BeamFailureRecoveryConfig to the terminal device to send the first multi-PRACH transmission configuration to the terminal device, which can improve the accuracy of sending the first multi-PRACH transmission configuration. In the embodiments of the present disclosure, the terminal device can transmit the multiple PRACHs on the PRACH resource through the SSB usage mode indicated by the first multi-PRACH transmission configuration sent by the network side device, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 9 is a schematic flowchart of a method for supporting a multi-PRACH transmission configuration across SSBs provided by an embodiment of the present disclosure. The method is performed by a network side device. As shown in FIG. 9, the method may include steps 901 to 902.

In the step 901, a second multi-PRACH transmission configuration is sent to a terminal device through a broadcast signaling or through a dedicated signaling, and the second multi-PRACH transmission configuration is configured to indicate a SSB usage mode corresponding to a PRACH resource used by the terminal device to send, according to the multi-PRACH transmission configuration, a plurality of PRACH transmissions.

In the step 902, a plurality of PRACHs transmitted on the PRACH resource by the terminal device through the SSB usage mode are received.

In an embodiment of the present disclosure, the broadcast signaling includes System Message Block 1 (SIB1),

In an embodiment of the present disclosure, the dedicated signaling includes at least one of:
a Radio Resource Control (RRC) Reconfiguration message;
a RRCResume message;
a RRCRelease message; or
a RRCSetup message.

In summary, in the embodiments of the present disclosure, the second multi-PRACH transmission configuration is sent to the terminal device through the broadcast signaling or through the dedicated signaling, and the second multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that the second multi-PRACH transmission configuration is sent to the terminal device through the broadcast signaling or through the dedicated signaling, which can improve the accuracy of the sending of the second multi-PRACH transmission configuration. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 10 is a schematic flowchart of a method for supporting a multi-PRACH transmission configuration across SSBs provided by an embodiment of the present disclosure. The method is performed by a network side device. As shown in FIG. 10, the method may include steps 1001 and 1002.

In the step 1001, a common Random Access Channel (RACH) configuration is sent to a terminal device, a second multi-PRACH transmission configuration is carried in the RACH configuration, and the second multi-PRACH transmission configuration is configured to indicate a SSB usage mode corresponding to a PRACH resource used by the terminal device to send, according to the multi-PRACH transmission configuration, a plurality of PRACH transmissions.

In the step 1002, a plurality of PRACHs transmitted on the PRACH resource by the terminal device through the SSB usage mode are received.

In an embodiment of the present disclosure, the RACH configuration includes common RACH resources separately configured on individual Bandwidth Parts (BWPs).

In an embodiment of the present disclosure, sending the RACH configuration to the terminal device includes:
sending first RACH-ConfigCommon in an initial BWP configuration of SIB1 to the terminal device, wherein the RACH configuration is carried in the first RACH-ConfigCommon.

In an embodiment of the present disclosure, sending the RACH configuration to the terminal device includes:
sending second RACH-ConfigCommon of a BWP configuration of the RRCReconfiguration message to the terminal device, wherein the RACH configuration is carried in the second RACH-ConfigCommon.

In an embodiment of the present disclosure, sending the multi-PRACH transmission configuration to the terminal device includes:
sending a dedicated RACH configuration to the terminal device, wherein the second multi-PRACH transmission configuration is carried in the dedicated RACH configuration.

In an embodiment of the present disclosure, sending the dedicated RACH configuration to the terminal device includes:
in response to a CBRA triggered by a beam failure recovery, sending BeamFailureRecoveryConfig to the terminal device, wherein the second multi-PRACH transmission configuration configured in the dedicated RACH configuration is carried in the BeamFailureRecoveryConfig.

In an embodiment of the present disclosure, sending the multi-PRACH transmission configuration to the terminal device includes:
in response to a CBRA triggered by Pscell addition or change, sending RACH-ConfigDedicated to the terminal device, wherein the second multi-PRACH transmission configuration configured in the dedicated RACH configuration is carried in the RACH-ConfigDedicated.

For example, in an embodiment of the present disclosure, sending the multi-PRACH transmission configuration to the terminal device includes:
in response to a CBRA triggered by a handover, sending RACH-ConfigDedicated to the terminal device, wherein the second multi-PRACH transmission configuration configured in the dedicated RACH configuration is carried in the RACH-ConfigDedicated.

In summary, in the embodiments of the present disclosure, the RACH configuration is sent to the terminal device, the RACH configuration carries the second multi-PRACH transmission configuration, and the second multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that the RACH configuration is sent to the terminal device so as to send the second multi-PRACH transmission configuration to the terminal device, which can improve the accuracy of sending the second multi-PRACH transmission configuration. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

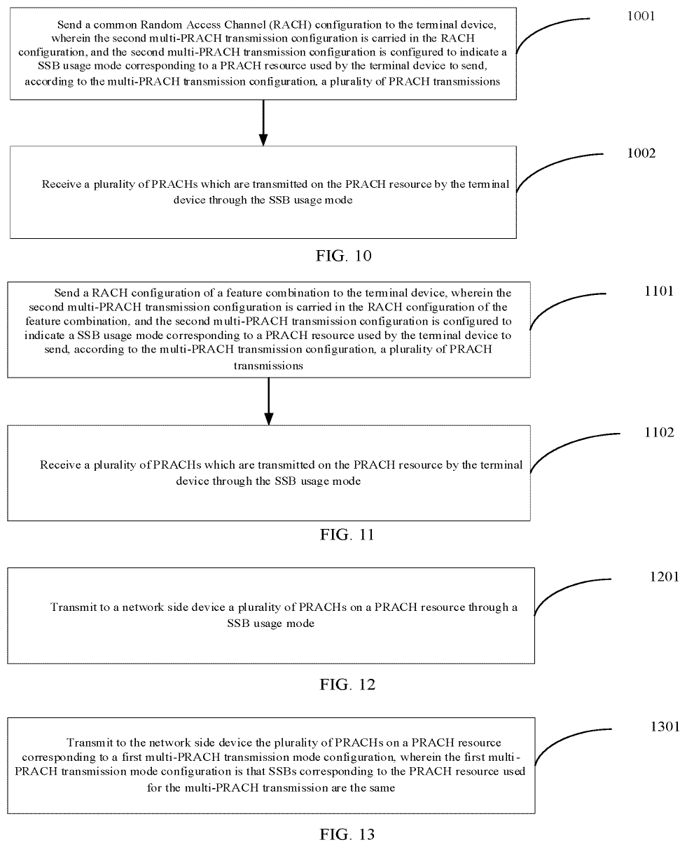

FIG. 11 is a schematic flowchart of a method for supporting a multi-PRACH transmission configuration across SSBs provided by an embodiment of the present disclosure. The method is performed by a network side device. As shown in FIG. 11, the method may include steps 1101 and 1102.

In the step 1101, a RACH configuration of a feature combination is sent to a terminal device, a second multi-PRACH transmission configuration is carried in the RACH configuration of the feature combination, and the second multi-PRACH transmission configuration is configured to indicate a SSB usage mode corresponding to a PRACH resource used by the terminal device to send, according to the multi-PRACH transmission configuration, a plurality of PRACH transmissions.

In the step 1102, a plurality of PRACHs transmitted on the PRACH resource by the terminal device through the SSB usage mode are received.

In an embodiment of the present disclosure, the feature combination includes a Coverage Enhancement feature, and the Coverage Enhancement feature is configured to indicate a Coverage Enhancement feature that supports a second multi-PRACH transmission.

For example, the feature combination may include at least one of:
Coverage Enhancement;
Reduced capability (RedCap);
Small Data Transmission (SDT); or
Slice.

In summary, in the embodiments of the present disclosure, the RACH configuration of the feature combination is sent to the terminal device, the RACH configuration of the feature combination carries the second multi-PRACH transmission configuration, and the second multi-PRACH transmission configuration is configured to indicate a SSB usage mode corresponding to a PRACH resource used by the terminal device to send, according to the multi-PRACH transmission configuration, a plurality of PRACH transmissions; and the plurality of PRACHs transmitted on the PRACH resource by the terminal device through the SSB usage mode are received. The embodiments of the present disclosure specifically disclose that the RACH configuration of the feature combination is sent to the terminal device so as to send the second multi-PRACH transmission configuration to the terminal device, which can improve the accuracy of sending the second multi-PRACH transmission configuration. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 12 is a schematic flowchart of a method for supporting a multi-PRACH transmission configuration across SSBs provided by an embodiment of the present disclosure. The method is performed by a terminal device. As shown in FIG. 12, the method may include step 1201.

In the step 1201, a plurality of PRACHs are transmitted to a network side device on a PRACH resource through a SSB usage mode.

In an embodiment of the present disclosure, transmitting to the network side device the plurality of PRACHs on the PRACH resource through the SSB usage mode includes at least one of:
transmitting to the network side device the plurality of PRACHs on a PRACH resource corresponding to a first multi-PRACH transmission mode configuration, wherein the first multi-PRACH transmission mode configuration is that SSBs corresponding to the PRACH resource used for the multi-PRACH transmission are the same; or
transmitting to the network side device the plurality of PRACHs on a PRACH resource corresponding to a second multi-PRACH transmission mode configuration, wherein the second multi-PRACH transmission mode configuration is that time domain random access occasion (RO) resources used by the multi-PRACH transmission belong to the same SSB or different SSBs.

In an embodiment of the present disclosure, transmitting to the network side device the plurality of PRACHs on the PRACH resource corresponding to the first multi-PRACH transmission mode configuration includes at least one of:
according to the first multi-PRACH transmission mode configuration, transmitting to the network side device the plurality of PRACHs through a PRACH resource corresponding to a first multi-PRACH transmission in which across-SSB is allowed; or
according to the first multi-PRACH transmission mode configuration, transmitting to the network side device the plurality of PRACHs through a PRACH resource corresponding to a first multi-PRACH transmission in which the across-SSB is not allowed.

For example, in an embodiment of the present disclosure, transmitting to the network side device the plurality of PRACHs on the PRACH resource corresponding to the second multi-PRACH transmission mode configuration includes at least one of:
according to the second multi-PRACH transmission mode configuration, transmitting to the network side device the plurality of PRACHs on A PRACH resource corresponding to a second multi-PRACH transmission in which a SSB gap between PRACH transmissions is allowed; or
according to the second multi-PRACH transmission mode configuration, transmitting to the network side device the plurality of PRACHs on A PRACH resource corresponding to a second multi-PRACH transmission in which the SSB gap between the PRACH transmissions is not allowed.

For example, in an embodiment of the present disclosure, the method further includes:
sending PRACH capability information to the network side device, wherein the PRACH capability information is configured to indicate capability information of the terminal device supporting multi-PRACH transmission.

For example, in an embodiment of the present disclosure, sending the PRACH capability information to the network side device includes;
sending UECapabilityInformation to the network side device, wherein the PRACH capability information is carried in the UECapability Information.

Further, in an embodiment of the present disclosure, the PRACH capability information includes at least one of
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

For example, in an embodiment of the present disclosure, before transmitting to the network side device the plurality of PRACHs on the PRACH resource through the SSB usage mode, the method further includes:
receiving a multi-PRACH transmission configuration sent by the network side device, wherein the multi-PRACH transmission configuration is configured to indicate the SSB usage mode corresponding to the PRACH resource used by the terminal device to send, according to the multi-PRACH transmission configuration, a plurality of PRACH transmissions.

For example, in an embodiment of the present disclosure, receiving the multi-PRACH transmission configuration sent by the network side device includes at least one of:
receiving the multi-PRACH transmission configuration sent by the network side device, wherein the multi-PRACH transmission configuration includes a first multi-PRACH transmission configuration based on a CFRA and a second multi-PRACH transmission configuration based on a CBRA.

In summary, in the embodiments of the present disclosure, the multiple PRACHs are transmitted to the network side device on the PRACH resources through the SSB usage mode. In the embodiments of the present disclosure, the terminal device can transmit the plurality of PRACHs on the PRACH resource through the SSB usage mode, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 13 is a schematic flowchart of a method for supporting a multi-PRACH transmission configuration across SSBs provided by an embodiment of the present disclosure. The method is performed by a terminal device. As shown in FIG. 13, the method may include step 1301.

In the step 1301, a plurality of PRACHs are transmitted to a network side device on a PRACH resource corresponding to a first multi-PRACH transmission mode configuration, and the first multi-PRACH transmission mode configuration is that SSBs corresponding to the PRACH resource used for the multi-PRACH transmission are the same.

In an embodiment of the present disclosure, the SSBs corresponding to the PRACH resource used for the multi-PRACH transmission being the same may be, for example, beams being the same, which may mean that beam identifiers (Channel State Information-Reference Signal-Index (CSI-RS-Index) or SSB-Index) corresponding to the beams are the same, or mean the same beam. The multiple PRACH transmissions are sent on different RACH Occasions (ROs) associated with the same beam.

For example, the multi-PRACH transmission mode configuration may be sent by the network side device, or may be agreed by a system without the need for the network side device to set the PRACH transmission mode configuration. For example, the network side device may indicate the beam identifier (CSI-RS-Index or SSB-Index) of the beam for sending the multiple PRACH transmissions.

For example, in an embodiment of the present disclosure, transmitting to the network side device the plurality of PRACHs on the PRACH resource corresponding to the first multi-PRACH transmission mode configuration includes at least one of:
according to the first multi-PRACH transmission mode configuration, transmitting to the network side device the plurality of PRACHs through a PRACH resource corresponding to a first multi-PRACH transmission in which across-SSB is allowed; or
according to the first multi-PRACH transmission mode configuration, transmitting to the network side device the plurality of PRACHs through a PRACH resource corresponding to a first multi-PRACH transmission in which the across-SSB is not allowed.

In an embodiment of the present disclosure, for example, in the first multi-PRACH transmission in which the across-SSB is allowed, after the terminal device sends one or more PRACH transmissions on one or more ROs associated with one SSB, if the total number of PRACH transmissions is less than the configured value N, and if there are no remaining ROs in the current SSB, the UE sends the remaining number of PRACH transmissions in the RO associated with the next transmission time of this SSB. N is a positive integer.

In an embodiment of the present disclosure, for example, in the first multi-PRACH transmission in which the across-SSB is not allowed, after the terminal device sends one or more PRACH transmissions on one or more ROs associated with one SSB, if the total number of PRACH transmissions is less than the configured value N, and if there are no remaining ROs in the current SSB, the terminal device no longer sends the remaining number of PRACH transmissions. N is a positive integer.

In summary, in the embodiments of the present disclosure, the multiple PRACHs are transmitted to the network side device on the PRACH resource corresponding to the first multi-PRACH transmission mode configuration, and the first multi-PRACH transmission mode configuration is that the SSBs corresponding to the PRACH resource used for the multi-PRACH transmission are the same. In the embodiments of the present disclosure, the terminal device can transmit the multiple PRACHs on the PRACH resource corresponding to the first multi-PRACH transmission mode configuration, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

FIG. 14 is a schematic flowchart of a method for supporting a multi-PRACH transmission configuration across SSBs provided by an embodiment of the present disclosure. The method is performed by a terminal device. As shown in FIG. 14, the method may include step 1401.

In the step 1401, a plurality of PRACHs are transmitted to a network side device on a PRACH resource corresponding to a second multi-PRACH transmission mode configuration, and the second multi-PRACH transmission mode configuration is that time domain Random access Occasion (RO) resources used by the multi-PRACH transmission belong to the same SSB or different SSBs.

In an embodiment of the present disclosure, the second multi-PRACH transmission mode configuration is configured to indicate that beams are different, which may, for example, mean that beam identifiers (CSI-RS-Index or SSB-Index) corresponding to the beams are different, or mean different beams. For example, the SSBs sent by the network side device are SSB1, SSB2, SSB3, SSB4, SSB1, SSB2, SSB3 in chronological order. Then the first SSB1 and the second SSB1 are not the same beam.

For example, different beams correspond to two modes: mode 1 in which different PRACH transmissions must be on ROs associated with different beams; and mode 2 in which different PRACH transmissions can be on ROs associated with different beams, or on ROs associated with the same beam, or part of the transmissions can be on ROs associated with one beam, and the other part can be on ROs associated with another beam.

For example, in an embodiment of the present disclosure, transmitting to the network side device the plurality of PRACHs on the PRACH resource corresponding to the second multi-PRACH transmission mode configuration includes at least one of:
according to the second multi-PRACH transmission mode configuration, transmitting to the network side device the plurality of PRACHs on A PRACH resource corresponding to a second multi-PRACH transmission in which a SSB gap between PRACH transmissions is allowed; or
according to the second multi-PRACH transmission mode configuration, transmitting to the network side device the plurality of PRACHs on A PRACH resource corresponding to a second multi-PRACH transmission in which the SSB gap between the PRACH transmissions is not allowed.

For example, in an embodiment of the present disclosure, in the second multi-PRACH transmission in which the SSB gap between the PRACH transmissions is allowed, for example, when the terminal device sends one or more PRACH transmissions on one or more ROs associated with one SSB, if the total number of PRACH transmissions is less than the configured value N, and there are no remaining ROs in the current SSB, but the RSRP of the next SSB does not meet a threshold requirement, the terminal device can skip the RO of the SSB and use a RO resource of the next SSB whose RSRP meets the threshold.

For example, in an embodiment of the present disclosure, after the terminal device sends one or more PRACH transmissions on one or more ROs associated with one SSB1, if the total number of PRACH transmissions is less than the configured value N, and there are no remaining ROs in the current SSB1, but the RSRP of SSB2 does not meet the threshold requirement, the terminal device can skip the RO of SSB2, and when the RSRP of SSB3 meets the threshold, the terminal device can use the RO resource of SSB3.

For example, in an embodiment of the present disclosure, in the second multi-PRACH transmission in which the SSB gap between the PRACH transmissions is not allowed, after the terminal device sends one or more PRACH transmissions on one or more ROs associated with one SSB, if the total number of PRACH transmissions is less than the configured value N, and if there are no remaining ROs in the current SSB, but the RSRP of the next SSB does not meet the threshold requirement, the terminal device stops the remaining number of multiple PRACH transmissions.

For example, in an embodiment of the present disclosure, after the terminal device sends one or more PRACH transmissions on one or more ROs associated with one SSB1, if the total number of PRACH transmissions is less than the configured value N, and if there are no remaining ROs in the current SSB1, but the RSRP of SSB2 does not meet the threshold requirement, the terminal device stops the remaining number of multiple PRACH transmissions.

In summary, in the embodiments of the present disclosure, the multiple PRACHs are transmitted to the network side device on the PRACH resource corresponding to the second multi-PRACH transmission mode configuration, and the second multi-PRACH transmission mode configuration is that time domain Random access Occasion (RO) resources used by the multi-PRACH transmission belong to the same SSB or different SSBs. In the embodiments of the present disclosure, the terminal device can transmit the multiple PRACHs to the network side device on the PRACH resource corresponding to the second multi-PRACH transmission mode configuration, thereby reducing the situation where the plurality of PRACHs cannot be transmitted, and improving the probability of successful random access. The present disclosure provides a processing method for a situation of “multi-PRACH transmission configuration”, so that the terminal device can transmit the plurality of PRACHs on the PRACH resource through the SSB usage mode, thereby improving the coverage of the PRACH channel.

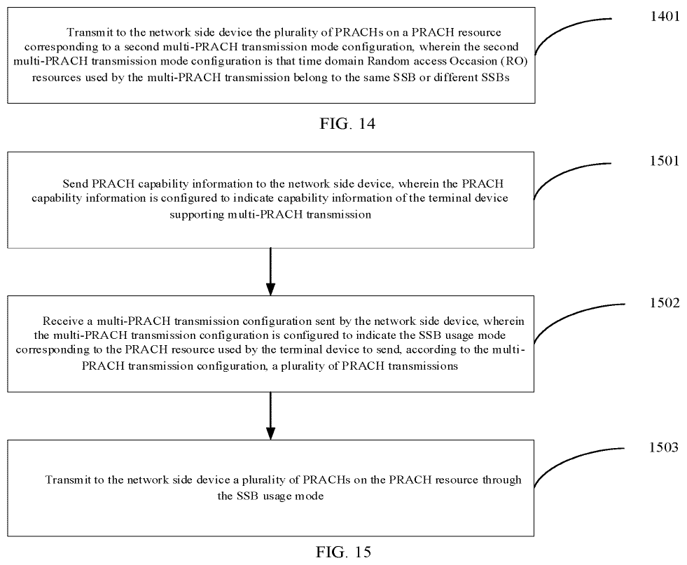

FIG. 15 is a schematic flowchart of a method for supporting a multi-PRACH transmission configuration across SSBs provided by an embodiment of the present disclosure. The method is performed by a terminal device. As shown in FIG. 15, the method may include steps 1501 to 1503.

In the step 1501, PRACH capability information is sent to a network side device, and the PRACH capability information is configured to indicate capability information of the terminal device supporting multi-PRACH transmission.

In an embodiment of the present disclosure, sending the PRACH capability information to the network side device includes:
sending UECapabilityInformation to the network side device, wherein the PRACH capability information is carried in the UECapability Information.

For example, in an embodiment of the present disclosure, the PRACH capability information includes at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

In the step 1502, a multi-PRACH transmission configuration sent by the network side device is received, and the multi-PRACH transmission configuration is configured to indicate the SSB usage mode corresponding to a PRACH resource used by the terminal device to send, according to the multi-PRACH transmission configuration, a plurality of PRACH transmissions.

In an embodiment of the present disclosure, receiving the multi-PRACH transmission configuration sent by the network side device includes at least one of:
receiving the multi-PRACH transmission configuration sent by the network side device, wherein the multi-PRACH transmission configuration includes a first multi-PRACH transmission configuration based on a CFRA and a second multi-PRACH transmission configuration based on a CBRA.

In the step 1503, the plurality of PRACHs are transmitted to the network side device on the PRACH resource through the SSB usage mode.

For other detailed descriptions of the steps 1501 to 1503, reference may be made to the description of the above embodiments, which will not be repeated here.

In summary, in the embodiments of the present disclosure, the PRACH capability information is sent to the network side device, and the PRACH capability information is configured to indicate the capability information of the terminal device supporting the multi-PRACH transmission; the multi-PRACH transmission configuration sent by the network side device is received, and the multi-PRACH transmission configuration is configured to indicate the SSB usage mode corresponding to the PRACH resource used by the terminal device to send, according to the multi-PRACH transmission configuration, the plurality of PRACH transmissions; and the plurality of PRACH transmissions are transmitted to the network side device on the PRACH resource through the SSB usage mode. In the embodiments of the present disclosure, the terminal device sends the PRACH capability information to the network side device to receive the multi-PRACH transmission configuration sent by the network side device, which can improve the accuracy of the sending of the multi-PRACH transmission configuration. The present disclosure provides a processing method for a situation of “multi-PRACH transmission configuration”, so as to reduce the duration of the multi-PRACH transmission configuration, improve the efficiency of the multi-PRACH transmission configuration, and thus improve the convenience of the parameter adjustment by the network side device.

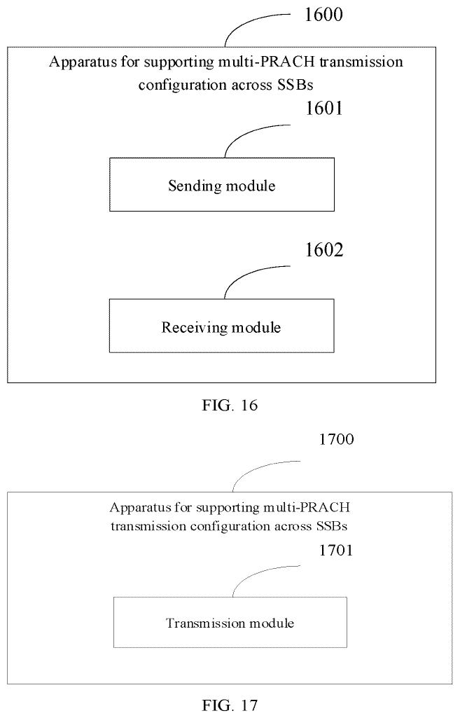

FIG. 16 is a schematic structural diagram of an apparatus for supporting a multi-PRACH transmission configuration across SSBs provided by an embodiment of the present disclosure. As shown in FIG. 16, the apparatus 1600 may include;
a sending module 1601, configured to send a multi-PRACH transmission configuration to a terminal device, wherein the multi-PRACH transmission configuration is configured to indicate a SSB usage mode corresponding to a PRACH resource used by the terminal device to send, according to the multi-PRACH transmission configuration, a plurality of PRACH transmissions; and
a receiving module 1602, configured to receive a plurality of PRACHs which are transmitted on the PRACH resource by the terminal device through the SSB usage mode.

In summary, in the apparatus for supporting the multi-PRACH transmission configuration across the SSBs in the embodiments of the present disclosure, the multi-PRACH transmission configuration can be sent to the terminal device by the sending module, and the multi-PRACH transmission configuration is configured to indicate the SSB usage mode corresponding to the PRACH resource used by the terminal device to send, according to the multi-PRACH transmission configuration, the plurality of PRACH transmissions; and the plurality of PRACHs transmitted on the PRACH resource by the terminal device through the SSB usage mode can be received by the receiving module. In the embodiment of the present disclosure, the apparatus for supporting the multi-PRACH transmission configuration across the SSBs can send the multi-PRACH transmission configuration to the terminal device, so that the terminal device transmits the multiple PRACHs on the PRACH resource through the SSB usage mode, thereby reducing the situation where the multiple PRACHs cannot be transmitted, and improving the probability of the successful random access. The present disclosure provides a processing apparatus for a situation of “multi-PRACH transmission configuration”, so that the terminal device transmits the multiple PRACHs on the PRACH resource through the SSB usage mode, improving the coverage of the PRACH channel.

In an embodiment of the present disclosure, when sending the multi-PRACH transmission configuration to the terminal device, the sending module 1601 is specifically configured to:
send a multi-PRACH transmission mode configuration to the terminal device.

In an embodiment of the present disclosure, when sending the multi-PRACH transmission mode configuration to the terminal device, the sending module 1601 is specifically configured to perform at least one of:
sending a first multi-PRACH transmission mode configuration to the terminal device, wherein the first multi-PRACH transmission mode configuration is that SSBs corresponding to the PRACH resource are the same; or
sending a second multi-PRACH transmission mode configuration to the terminal device, wherein the second multi-PRACH transmission mode configuration is that SSBs corresponding to the PRACH resource are different.

In an embodiment of the present disclosure, when sending the first multi-PRACH transmission mode configuration to the terminal device, the sending module 1601 is specifically configured to perform at least one of:
sending to the terminal device a first multi-PRACH transmission mode configuration in which cross-SSB is allowed; or
sending to the terminal device a first multi-PRACH transmission mode configuration in which the cross-SSB is not allowed.

In an embodiment of the present disclosure, when sending the second multi-PRACH transmission mode configuration to the terminal device, the sending module 1601 is specifically configured to perform at least one of:
sending to the terminal device a second multi-PRACH transmission mode configuration in which an SSB gap between PRACH transmissions is allowed; or
sending to the terminal device a second multi-PRACH transmission mode configuration in which the SSB gap between the PRACH transmissions is not allowed.

In an embodiment of the present disclosure, when sending the multi-PRACH transmission configuration to the terminal device, the sending module 1601 is specifically configured to perform at least one of:
sending the multi-PRACH transmission configuration to the terminal device, wherein the multi-PRACH transmission configuration includes a first multi-PRACH transmission configuration based on a Contention-Free Random Access (CFRA) and a second multi-PRACH transmission configuration based on a Contention-Based Random Access (CBRA).

In an embodiment of the present disclosure, a trigger mode of the CFRA includes at least one of:
a Physical Downlink Control Channel (PDCCH) trigger mode;
a handover trigger mode;
a beam failure recovery trigger mode; or
a PScell addition or change trigger mode.

In an embodiment of the present disclosure, when sending the multi-PRACH transmission configuration to the terminal device, the sending module 1601 is specifically configured to:
in response to a CFRA triggered by a PDCCH, send a PDCCH order to the terminal device, wherein the first multi-PRACH transmission configuration is carried in the PDCCH order,
In an embodiment of the present disclosure, when sending the multi-PRACH transmission configuration to the terminal device, the sending module 1601 is specifically configured to:
in response to a CFRA triggered by Pscell addition or change, send RACH-ConfigDedicated to the terminal device, wherein the first multi-PRACH transmission configuration is carried in a CFRA configuration of the RACH-ConfigDedicated.

In an embodiment of the present disclosure, when sending the multi-PRACH transmission configuration to the terminal device, the sending module 1601 is specifically configured to:
in response to a CFRA triggered by a handover, send RACH-ConfigDedicated to the terminal device, wherein the first multi-PRACH transmission configuration is carried in a CFRA configuration of the RACH-ConfigDedicated.

In an embodiment of the present disclosure, when sending the multi-PRACH transmission configuration to the terminal device, the sending module 1601 is specifically configured to:
in response to a CFRA triggered by a beam failure recovery, send BeamFailureRecoveryConfig to the terminal device, wherein the first multi-PRACH transmission configuration is carried in the BeamFailureRecoveryConfig.

In an embodiment of the present disclosure, when sending the multi-PRACH transmission configuration to the terminal device, the sending module 1601 is specifically configured to:
send the second multi-PRACH transmission configuration to the terminal device through a broadcast signaling or through a dedicated signaling.

In an embodiment of the present disclosure, the broadcast signaling includes System Message Block 1 (SIB1).

In an embodiment of the present disclosure, the dedicated signaling includes at least one of:
a Radio Resource Control (RRC) Reconfiguration message;
a RRCResume message
a RRCRelease message; or
a RRCSetup message.

In an embodiment of the present disclosure, when sending the multi-PRACH transmission configuration to the terminal device, the sending module 1601 is specifically configured to:
send a common Random Access Channel (RACH) configuration to the terminal device, wherein the second multi-PRACH transmission configuration is carried in the RACH configuration.

In an embodiment of the present disclosure, the RACH configuration includes common RACH resources separately configured on individual Bandwidth Parts (BWPs).

In an embodiment of the present disclosure, when sending the RACH configuration to the terminal device, the sending module 1601 is specifically configured to:
send first RACH-ConfigCommon in an initial BWP configuration of SIB1 to the terminal device, wherein the RACH configuration is carried in the first. RACH-ConfigCommon.

In an embodiment of the present disclosure, when sending the RACH configuration to the terminal device, the sending module 1601 is specifically configured to:
send second RACH-ConfigCommon of a BWP configuration of the RRCReconfiguration message to the terminal device, wherein the RACH configuration is carried in the second RACH-ConfigCommon.

In an embodiment of the present disclosure, when sending the multi-PRACH transmission configuration to the terminal device, the sending module 1601 is specifically configured to:
send a dedicated RACH configuration to the terminal device, wherein the second multi-PRACH transmission configuration is carried in the dedicated RACH configuration.

In an embodiment of the present disclosure, when sending the dedicated RACH configuration to the terminal device, the sending module 1601 is specifically configured to:
in response to a CBRA triggered by a beam failure recovery, send BeamFailureRecoveryConfig to the terminal device, wherein the second multi-PRACH transmission configuration configured in the dedicated RACH configuration is carried in the BeamFailureRecoveryConfig.

In an embodiment of the present disclosure, when sending the multi-PRACH transmission configuration to the terminal device, the sending module 1601 is specifically configured to:
in response to a CBRA triggered by Pscell addition or change, send RACH-ConfigDedicated to the terminal device, wherein the second multi-PRACH transmission configuration configured in the dedicated RACH configuration is carried in the RACH-ConfigDedicated.

In an embodiment of the present disclosure, when sending the multi-PRACH transmission configuration to the terminal device, the sending module 1601 is specifically configured to:
in response to a CBRA triggered by a handover, send RACH-ConfigDedicated to the terminal device, wherein the second multi-PRACH transmission configuration configured in the dedicated RACH configuration is carried in the RACH-ConfigDedicated.

In an embodiment of the present disclosure, when sending the multi-PRACH transmission configuration to the terminal device, the sending module 1601 is specifically configured to:
send a RACH configuration of a feature combination to the terminal device, wherein the second multi-PRACH transmission configuration is carried in the RACH configuration of the feature combination.

In an embodiment of the present disclosure, the feature combination includes a Coverage Enhancement feature, and the Coverage Enhancement feature is configured to indicate a Coverage Enhancement feature that supports a second multi-PRACH transmission.

In an embodiment of the present disclosure, the receiving module 1602 is further configured to receive PRACH capability information sent by the terminal device, wherein the PRACH capability information is configured to indicate capability information of the terminal device supporting multi-PRACH transmission.

In an embodiment of the present disclosure, when receiving the PRACH capability information sent by the terminal device, the receiving module 1602 is specifically configured to:
receive UECapabilityInformation sent by the terminal device, wherein the PRACH capability information is carried in the UECapabilityInformation.

In an embodiment of the present disclosure, the PRACH capability information includes at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

In an embodiment of the present disclosure, after receiving the PRACH capability information sent by the terminal device, the apparatus is further configured to:
based on the PRACH capability information, configure a multi-PRACH transmission mode configuration for the terminal device through a dedicated signaling.

FIG. 17 is a schematic structural diagram of an apparatus for supporting a multi-PRACH transmission configuration across SSBs provided by an embodiment of the present disclosure. As shown in FIG. 17, the apparatus 1700 may include:
a transmission module 1701, configured to transmit to a network side device a plurality of PRACHs on a PRACH resource through a SSB usage mode.

In summary, in the apparatus for supporting the multi-PRACH transmission configuration across the SSBs in the embodiments of the present disclosure, the transmission module can transmit the multiple PRACHs to the network side device on the PRACH resource through the SSB usage mode. In the embodiments of the present disclosure, the multi-PRACH transmission configuration can transmit the multiple PRACHs on the PRACH resource through the SSB usage mode, thereby reducing the situation where the multiple PRACHs cannot be transmitted, and improving the probability of the successful random access. The present disclosure provides a processing apparatus for a situation of “multi-PRACH transmission configuration”, so that the terminal device transmits the multiple PRACHs on the PRACH resource through the SSB usage mode, improving the coverage of the PRACH channel.

In an embodiment of the present disclosure, when transmitting to the network side device the plurality of PRACHs on the PRACH resource through the SSB usage mode, the transmission module 1701 is specifically configured to perform at least one of:
transmitting to the network side device the plurality of PRACHs on a PRACH resource corresponding to a first multi-PRACH transmission mode configuration, wherein the first multi-PRACH transmission mode configuration is that SSBs corresponding to the PRACH resource used for the multi-PRACH transmission are the same; or
transmitting to the network side device the plurality of PRACHs on a PRACH resource corresponding to a second multi-PRACH transmission mode configuration, wherein the second multi-PRACH transmission mode configuration is that time domain Random access Occasion (RO) resources used by the multi-PRACH transmission belong to the same SSB or different SSBs.

In an embodiment of the present disclosure, when transmitting to the network side device the plurality of PRACHs on the PRACH resource corresponding to the first multi-PRACH transmission mode configuration, the transmission module 1701 is specifically configured to perform at least one of:
according to the first multi-PRACH transmission mode configuration, transmitting to the network side device the plurality of PRACHs through a PRACH resource corresponding to a first multi-PRACH transmission in which across-SSB is allowed; or
according to the first multi-PRACH transmission mode configuration, transmitting to the network side device the plurality of PRACHs through a PRACH resource corresponding to a first multi-PRACH transmission in which the across-SSB is not allowed.

In an embodiment of the present disclosure, when transmitting to the network side device the plurality of PRACHs on the PRACH resource corresponding to the second multi-PRACH transmission mode configuration, the transmission module 1701 is specifically configured to perform at least one of:
according to the second multi-PRACH transmission mode configuration, transmitting to the network side device the plurality of PRACHs on a PRACH resource corresponding to a second multi-PRACH transmission in which a SSB gap between PRACH transmissions is allowed; or
according to the second multi-PRACH transmission mode configuration, transmitting to the network side device the plurality of PRACHs on a PRACH resource corresponding to a second multi-PRACH transmission in which the SSB gap between the PRACH transmissions is not allowed.

In an embodiment of the present disclosure, the transmission module 1701 is further configured to send PRACH capability information to the network side device, wherein the PRACH capability information is configured to indicate capability information of the terminal device supporting multi-PRACH transmission.

In an embodiment of the present disclosure, when sending the PRACH capability information to the network side device, the transmission module 1701 is specifically configured to:
send UECapabilityInformation to the network side device, wherein the PRACH capability information is carried in the UECapability Information.

In an embodiment of the present disclosure, the PRACH capability information includes at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

In an embodiment of the present disclosure, before transmitting to the network side device the plurality of PRACHs on the PRACH resource through the SSB usage mode, the apparatus is further configured to:
receive a multi-PRACH transmission configuration sent by the network side device, wherein the multi-PRACH transmission configuration is configured to indicate the SSB usage mode corresponding to the PRACH resource used by the terminal device to send, according to the multi-PRACH transmission configuration, a plurality of PRACH transmissions.

In an embodiment of the present disclosure, receiving the multi-PRACH transmission configuration sent by the network side device includes at least one of:
receiving the multi-PRACH transmission configuration sent by the network side device, wherein the multi-PRACH transmission configuration includes a first multi-PRACH transmission configuration based on a CFRA and a second multi-PRACH transmission configuration based on a CBRA.

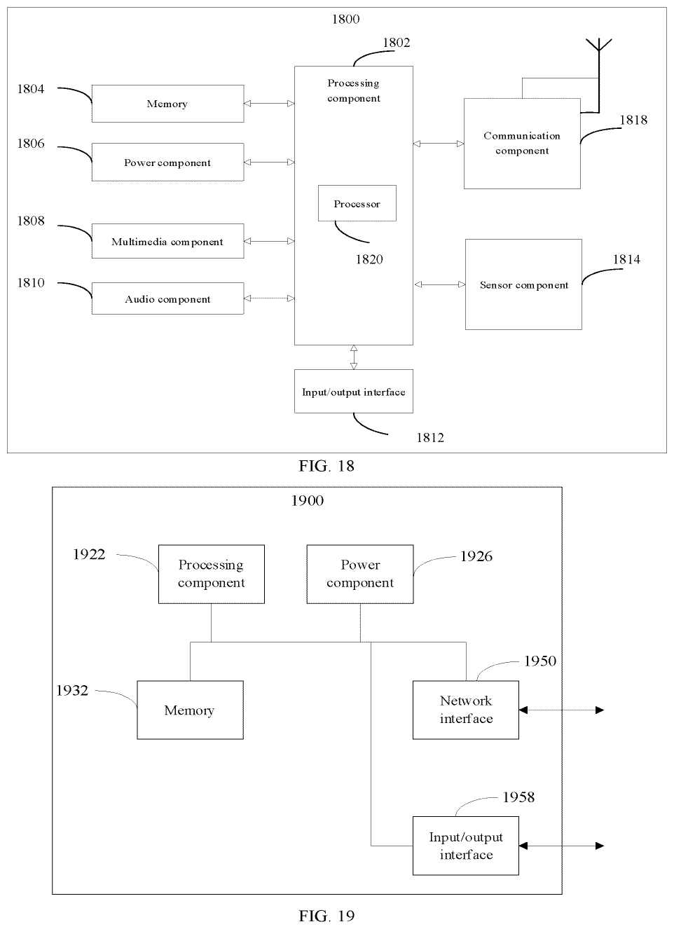

FIG. 18 is a block diagram of a User Equipment (UE) 1600 provided by an embodiment of the present disclosure. For example, the UE 1600 may be a mobile phone, a computer, a digital broadcast terminal device, a messaging device, a gaming console, a tablet, a medical device, an exercise device, a personal digital assistant, etc.

Referring to FIG. 18, the UE 1800 may include at least one of the following components: a processing component 1802, a memory 1804, a power component 1806, a multimedia component 1808, an audio component 1810, an input/output (I/O) interface 1812, a sensor component 1814, and a communication component 1818.

The processing component 1802 typically controls overall operations of the UE 1800, such as the operations associated with display, telephone calls, data communications, camera operations, and recording operations. The processing component 1802 may include at least one processor 1820 to execute instructions to perform all or part of the steps in the above described methods. Moreover, the processing component 1802 may include at least one module which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the UE 1800. Examples of such data include instructions for any applications or methods operated on the UE 1800, contact data, phonebook data, messages, pictures, video, etc. The memory 1804 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the UE 1800. The power component 1806 may include a power management system, at least one power source, and any other components associated with the generation, management, and distribution of power in the UE 1800.

The multimedia component 1808 includes a screen providing an output interface between the UE 1800 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up time and a pressure associated with the touch or swipe action. In some embodiments, the multimedia component 1808 includes a front camera and/or a rear camera. The front camera and the rear camera may receive an external multimedia datum while the UE 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 includes a microphone (MIC) configured to receive an external audio signal when the UE 1800 is in an operation mode, such as a call mode, a recording mode, and a voice recognition mode. The received audio signal may be further stored in the memory 1804 or transmitted via the communication component 1818. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and a locking button.

The sensor component 181814 includes at least one sensor to provide state assessments of various aspects of the UE 1800. For instance, the sensor component 1814 may detect an open/closed state of the UE 1800, relative positioning of components, e.g., the display and the keypad, of the UE 1800, a change in position of the UE 1800 or a component of the UE 1800, a presence or absence of user contact with the UE 1800, an orientation or an acceleration/deceleration of the UE 1800, and a change in temperature of the UE 1800. The sensor component 1814 may include a proximity sensor configured to detect the presence of nearby objects without any physical contact. The sensor component 1814 may further include a light sensor, such as a CMOS or CCD image sensor, for use in imaging applications. In some embodiments, the sensor component 1814 may further include an accelerometer sensor, a gyroscope sensor, a magnetic sensor, a pressure sensor, or a temperature sensor.

The communication component 1818 is configured to facilitate communication, wired or wirelessly, between the UE 1800 and other devices. The UE 1800 may access a wireless network based on a communication standard, such as WiFi, 2G, or 3G, or a combination thereof. In an embodiment, the communication component 1818 receives a broadcast signal or broadcast associated information from an external broadcast management system via a broadcast channel. In an embodiment, the communication component 1818 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the UE 1800 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic components, for performing the above described methods.

FIG. 19 is a block diagram of a network side device 1900 provided by an embodiment of the present disclosure. For example, the network side device 1900 may be provided as a network device. Referring to FIG. 19, the network side device 1900 includes a processing component 1922, which further includes at least one processor and a memory resource represented by a memory 1932 for storing instructions executable by the processing component 1922, such as an application program. The application program stored in the memory 1932 may include one or more modules, each corresponding to a set of instructions. In addition, the processing component 1922 is configured to execute the instructions to execute the aforementioned any method applied on the network side device, for example, the method shown in FIG. 1.

The network side device 1900 may further include: a power component 1926 configured to perform power management of the network side device 1900, a wired or wireless network interface 1950 configured to connect the network side device 1900 to the network, and an input/output (I/O) interface 1958. The network side device 1900 may operate an operating system stored in the memory 1932, such as Windows Server™, Mac OS X™, Unix™, Linux™, FreeBSD™, or the like.

In the above embodiments provided by the present disclosure, the methods provided by embodiments of the present disclosure are introduced from the perspectives of the network side device and the UE. In order to achieve various functions of the methods provided in embodiments of the present disclosure, the network side device and the UE may include hardware structures and software modules, and the various functions are implemented in the form of hardware structures, software modules, or hardware structures plus software modules. One of the various functions may be implemented in the form of hardware structures, software modules, or hardware structure plus software modules.

In the above embodiments provided by the present disclosure, the methods provided by embodiments of the present disclosure are introduced from the perspectives of the network side device and the UE, In order to achieve various functions of the methods provided in embodiments of the present disclosure, the network side device and the UE may include hardware structures and software modules, and the various functions are implemented in the form of hardware structures, software modules, or hardware structures plus software modules. One of the various functions may be implemented in the form of hardware structures, software modules, or hardware structure plus software modules.

Embodiments of the present disclosure provide a communication device. The communication device may include a transceiver module and a processing module. The transceiver module may include a transmitting module and/or a receiving module. The transmitting module is configured to implement a transmission function, and the receiving module is configured to implement a reception function. The transceiver module may implement the transmission function and/or the reception function.

The communication device may be a terminal device (such as the terminal device in the above method embodiments), a device in the terminal device, or a device that can be used in conjunction with the terminal device. Alternatively, the communication device may be a network device, a device in the network device, or a device that can be used in conjunction with the network device.

Embodiments of the present disclosure provide another communication device. The communication device may be a network device, or may be a terminal device (such as the terminal device in the above method embodiments), or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication device may include one or more processors. The processor may be a general-purpose processor or a dedicated processor, or the like. For example, the processor may be a baseband processor or a central processing unit. The baseband processor can be used to process communication protocols and communication data. The central processor can be used to control the communication devices (such as network side devices, baseband chips, terminal devices, terminal device chips, DU or CU, or the like), execute computer programs, and process data for the computer programs.

In embodiments of the present disclosure, the communication device may further include one or more memories, on which a computer program may be stored. The processor executes the computer program, so that the communication device performs the method described in the above method embodiments. In embodiments of the present disclosure, the memory may also store data. The communication device and the memory can be provided separately or integrated together.

In embodiments of the present disclosure, the communication device may further include a transceiver and an antenna. The transceiver may be referred to as a transceiver unit, a transceiver, a transceiver circuit, or the like, and is used to implement transceiver functions. The transceiver may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

In embodiments of the present disclosure, the communication device may further include one or more interface circuits. The interface circuit is used to receive code instructions and transmit the code instructions to the processor. The processor executes the code instructions to cause the communication device to perform the method described in the above method embodiments.

The communication device is a network side device, and the processor is configured to execute any method shown in FIGS. 1 to 11.

The communication device is a terminal device (such as the terminal device in the foregoing method embodiments), and the processor is configured to execute the method shown in any one of FIGS. 12-15.

In an implementation of the present disclosure, the processor may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In an implementation of the present disclosure, the processor may be stored with a computer program, and the computer program is executed by the processor, causing the communication device to perform the method described in the above method embodiments. The computer program may be solidified in the processor, in which case the processor may be implemented by hardware.

In an implementation of the present disclosure, the communication device may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BICMOS), silicon germanium (SiGe), gallium arsenide (GaAs), and the like.

The communication device described in the above embodiments may be the network device or the terminal device (e.g., the terminal device in the above method embodiments), but the scope of the communication device described in the present disclosure is not limited thereto, and the structure of the communication device may not be limited. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

In a case that the communication device may be a chip or a system on a chip, the chip includes a processor and an interface. The number of processors may be one or more, and the number of interfaces may be multiple.

In an embodiment of the present disclosure, the chip further includes a memory, and the memory is configured to store necessary computer programs and data.

The present disclosure provides a method and apparatus for supporting a multi-PRACH transmission configuration across SSBs, a device and a storage medium, so as to reduce a duration of the multi-PRACH transmission configuration, improve the efficiency of the multi-PRACH transmission configuration, and thus improve the convenience of parameter adjustment by a network side device.

An aspect of embodiments of the present disclosure provides a method for supporting a multi-Physical Random Access Channel (PRACH) transmission configuration across Synchronization Signal Blocks (SSBs), which is performed by a network side device, and the method includes:
sending a multi-PRACH transmission configuration to a terminal device, wherein the multi-PRACH transmission configuration is configured to indicate a SSB usage mode corresponding to a PRACH resource used by the terminal device to send, according to the multi-PRACH transmission configuration, a plurality of PRACH transmissions; and
receiving a plurality of PRACHs which are transmitted on the PRACH resource by the terminal device through the SSB usage mode.

In an embodiment of the present disclosure, sending the multi-PRACH transmission configuration to the terminal device includes:
sending a multi-PRACH transmission mode configuration to the terminal device.

In an embodiment of the present disclosure, sending the multi-PRACH transmission mode configuration to the terminal device includes at least one of:
sending a first multi-PRACH transmission mode configuration to the terminal device, wherein the first multi-PRACH transmission mode configuration is that SSBs corresponding to the PRACH resource are the same; or
sending a second multi-PRACH transmission mode configuration to the terminal device, wherein the second multi-PRACH transmission mode configuration is that SSBs corresponding to the PRACH resource are different.

In an embodiment of the present disclosure, sending the first multi-PRACH transmission mode configuration to the terminal device includes at least one of:
sending to the terminal device a first multi-PRACH transmission mode configuration in which cross-SSB is allowed; or
sending to the terminal device a first multi-PRACH transmission mode configuration in which the cross-SSB is not allowed.

In an embodiment of the present disclosure, sending the second multi-PRACH transmission mode configuration to the terminal device includes at least one of:
sending to the terminal device a second multi-PRACH transmission mode configuration in which an SSB gap between PRACH transmissions is allowed; or
sending to the terminal device a second multi-PRACH transmission mode configuration in which the SSB gap between the PRACH transmissions is not allowed.

In an embodiment of the present disclosure, sending the multi-PRACH transmission configuration to the terminal device includes at least one of:
sending the multi-PRACH transmission configuration to the terminal device, wherein the multi-PRACH transmission configuration includes a first multi-PRACH transmission configuration based on a Contention-Free Random Access (CFRA) and a second multi-PRACH transmission configuration based on a Contention-Based Random Access (CBRA).

In an embodiment of the present disclosure, a trigger mode of the CFRA includes at least one of:
a Physical Downlink Control Channel (PDCCH) trigger mode;
a handover trigger mode;
a beam failure recovery trigger mode; or
a PScell addition or change trigger mode.

In an embodiment of the present disclosure, sending the multi-PRACH transmission configuration to the terminal device includes:
in response to a CFRA triggered by a PDCCH, sending a PDCCH order to the terminal device, wherein the first multi-PRACH transmission configuration is carried in the PDCCH order.

In an embodiment of the present disclosure, sending the multi-PRACH transmission configuration to the terminal device includes:
in response to a CFRA triggered by Pscell addition or change, sending RACH-ConfigDedicated to the terminal device, wherein the first multi-PRACH transmission configuration is carried in a CFRA configuration of the RACH-ConfigDedicated.

In an embodiment of the present disclosure, sending the multi-PRACH transmission configuration to the terminal device includes:
in response to a CFRA triggered by a handover, sending RACH-ConfigDedicated to the terminal device, wherein the first multi-PRACH transmission configuration is carried in a CFRA configuration of the RACH-ConfigDedicated.

In an embodiment of the present disclosure, sending the multi-PRACH transmission configuration to the terminal device includes:
in response to a CFRA triggered by a beam failure recovery, sending BeamFailureRecoveryConfig to the terminal device, wherein the first multi-PRACH transmission configuration is carried in the BeamFailureRecoveryConfig.

In an embodiment of the present disclosure, sending the multi-PRACH transmission configuration to the terminal device includes:
sending the second multi-PRACH transmission configuration to the terminal device through a broadcast signaling or through a dedicated signaling.

In an embodiment of the present disclosure, the broadcast signaling includes System Message Block 1 (SIB1).

In an embodiment of the present disclosure, the dedicated signaling includes at least one of:
a Radio Resource Control (RRC) Reconfiguration message;
a RRCResume message;
a RRCRelease message; or
a RRCSetup message.

In an embodiment of the present disclosure, sending the multi-PRACH transmission configuration to the terminal device includes:
sending a common Random Access Channel (RACH) configuration to the terminal device, wherein the second multi-PRACH transmission configuration is carried in the RACH configuration.

In an embodiment of the present disclosure, the RACH configuration includes common RACH resources separately configured on individual Bandwidth Parts (BWPs).

In an embodiment of the present disclosure, sending the RACH configuration to the terminal device includes:
sending first RACH-ConfigCommon in an initial BWP configuration of SIB1 to the terminal device, wherein the RACH configuration is carried in the first RACH-ConfigCommon.

In an embodiment of the present disclosure, sending the RACH configuration to the terminal device includes:
sending second RACH-ConfigCommon of a BWP configuration of the RRCReconfiguration message to the terminal device, wherein the RACH configuration is carried in the second RACH-ConfigCommon.

In an embodiment of the present disclosure, sending the multi-PRACH transmission configuration to the terminal device includes:
sending a dedicated RACH configuration to the terminal device, wherein the second multi-PRACH transmission configuration is carried in the dedicated RACH configuration.

In an embodiment of the present disclosure, sending the dedicated RACH configuration to the terminal device includes:
in response to a CBRA triggered by a beam failure recovery, sending BeamFailureRecoveryConfig to the terminal device, wherein the second multi-PRACH transmission configuration configured in the dedicated RACH configuration is carried in the BeamFailureRecoveryConfig.

In an embodiment of the present disclosure, sending the multi-PRACH transmission configuration to the terminal device includes:
in response to a CBRA triggered by Pscell addition or change, sending RACH-ConfigDedicated to the terminal device, wherein the second multi-PRACH transmission configuration configured in the dedicated RACH configuration is carried in the RACH-ConfigDedicated.

In an embodiment of the present disclosure, sending the multi-PRACH transmission configuration to the terminal device includes:
in response to a CBRA triggered by a handover, sending RACH-ConfigDedicated to the terminal device, wherein the second multi-PRACH transmission configuration configured in the dedicated RACH configuration is carried in the RACH-ConfigDedicated.

In an embodiment of the present disclosure, sending the multi-PRACH transmission configuration to the terminal device includes:
sending a RACH configuration of a feature combination to the terminal device, wherein the second multi-PRACH transmission configuration is carried in the RACH configuration of the feature combination.

In an embodiment of the present disclosure, the feature combination includes a Coverage Enhancement feature, and the Coverage Enhancement feature is configured to indicate a Coverage Enhancement feature that supports a second multi-PRACH transmission.

In an embodiment of the present disclosure, the method further includes:
receiving PRACH capability information sent by the terminal device, wherein the PRACH capability information is configured to indicate capability information of the terminal device supporting multi-PRACH transmission.

In an embodiment of the present disclosure, receiving the PRACH capability information sent by the terminal device includes;
receiving UECapabilityInformation sent by the terminal device, wherein the PRACH capability information is carried in the UECapability Information.

In an embodiment of the present disclosure, the PRACH capability information includes at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

In an embodiment of the present disclosure, after receiving the PRACH capability information sent by the terminal device, the method further includes:
based on the PRACH capability information, configuring a multi-PRACH transmission mode configuration for the terminal device through a dedicated signaling.

Another aspect of embodiments of the present disclosure provides a method for supporting a multi-PRACH transmission configuration across SSBs, which is performed by a terminal device, and the method includes;
transmitting to a network side device a plurality of PRACHs on a PRACH resource through a SSB usage mode.

In an embodiment of the present disclosure, transmitting to the network side device the plurality of PRACHs on the PRACH resource through the SSB usage mode includes at least one of:
transmitting to the network side device the plurality of PRACHs on a PRACH resource corresponding to a first multi-PRACH transmission mode configuration, wherein the first multi-PRACH transmission mode configuration is that SSBs corresponding to the PRACH resource used for the multi-PRACH transmission are the same; or
transmitting to the network side device the plurality of PRACHs on a PRACH resource corresponding to a second multi-PRACH transmission mode configuration, wherein the second multi-PRACH transmission mode configuration is that time domain random access occasion (RO) resources used by the multi-PRACH transmission belong to the same SSB or different SSBs.

In an embodiment of the present disclosure, transmitting to the network side device the plurality of PRACHs on the PRACH resource corresponding to the first multi-PRACH transmission mode configuration includes at least one of:
according to the first multi-PRACH transmission mode configuration, transmitting to the network side device the plurality of PRACHs through a PRACH resource corresponding to a first multi-PRACH transmission in which across-SSB is allowed; or
according to the first multi-PRACH transmission mode configuration, transmitting to the network side device the plurality of PRACHs through a PRACH resource corresponding to a first multi-PRACH transmission in which the across-SSB is not allowed.

In an embodiment of the present disclosure, transmitting to the network side device the plurality of PRACHs on the PRACH resource corresponding to the second multi-PRACH transmission mode configuration includes at least one of:
according to the second multi-PRACH transmission mode configuration, transmitting to the network side device the plurality of PRACHs on A PRACH resource corresponding to a second multi-PRACH transmission in which a SSB gap between PRACH transmissions is allowed; or
according to the second multi-PRACH transmission mode configuration, transmitting to the network side device the plurality of PRACHs on A PRACH resource corresponding to a second multi-PRACH transmission in which the SSB gap between the PRACH transmissions is not allowed.

In an embodiment of the present disclosure, the method further includes:
sending PRACH capability information to the network side device, wherein the PRACH capability information is configured to indicate capability information of the terminal device supporting multi-PRACH transmission.

In an embodiment of the present disclosure, sending the PRACH capability information to the network side device includes:
sending UECapabilityInformation to the network side device, wherein the PRACH capability information is carried in the UECapabilityInformation.

In an embodiment of the present disclosure, the PRACH capability information includes at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

In an embodiment of the present disclosure, before transmitting to the network side device the plurality of PRACHs on the PRACH resource through the SSB usage mode, the method further includes:
receiving a multi-PRACH transmission configuration sent by the network side device, wherein the multi-PRACH transmission configuration is configured to indicate the SSB usage mode corresponding to the PRACH resource used by the terminal device to send, according to the multi-PRACH transmission configuration, a plurality of PRACH transmissions.

In an embodiment of the present disclosure, receiving the multi-PRACH transmission configuration sent by the network side device includes at least one of:
receiving the multi-PRACH transmission configuration sent by the network side device, wherein the multi-PRACH transmission configuration includes a first multi-PRACH transmission configuration based on a CFRA and a second multi-PRACH transmission configuration based on a CBRA.

Yet another aspect of embodiments of the present disclosure provides an apparatus for supporting a multi-PRACH transmission configuration across SSBs, including:
a sending module, configured to send a multi-PRACH transmission configuration to a terminal device, wherein the multi-PRACH transmission configuration is configured to indicate a SSB usage mode corresponding to a PRACH resource used by the terminal device to send, according to the multi-PRACH transmission configuration, a plurality of PRACH transmissions; and
a receiving module, configured to receive a plurality of PRACHs which are transmitted on the PRACH resource by the terminal device through the SSB usage mode.

Still another aspect of embodiments of the present disclosure provides an apparatus for supporting a multi-PRACH transmission configuration across SSBs, including;
a transmission module, configured to transmit to a network side device a plurality of PRACHs on a PRACH resource through a SSB usage mode.

Still another aspect of embodiments of the present disclosure provides a terminal device, including a processor and a memory, wherein a computer program is stored in the memory, and the processor executes the computer program stored in the memory to cause the communication device to execute the method provided in the aspect of the above embodiments.

Still another aspect of embodiments of the present disclosure provides a network side device, including a processor and a memory, wherein a computer program is stored in the memory, and the processor executes the computer program stored in the memory to cause the communication device to execute the method provided in the other aspect of the above embodiments.

Still another aspect of embodiments of the present disclosure provides a communication device, including a processor and an interface circuit; and
wherein the interface circuit is configured to receive code instructions and transmit the code instructions to the processor; and
the processor is configured to run the code instructions to execute the method provided in the aspect of the above embodiments.

Still another aspect of embodiments of the present disclosure provides a communication device, including a processor and an interface circuit; and
wherein the interface circuit is configured to receive code instructions and transmit the code instructions to the processor; and
the processor is configured to run the code instructions to execute the method provided in the other aspect of the above embodiments.

Still another aspect of embodiments of the present disclosure provides a computer-readable storage medium, configured to store instructions, wherein the instructions, when executed, cause the method provided in the aspect of the above embodiments.

Still another aspect of embodiments of the present disclosure provides a computer-readable storage medium, configured to store instructions, wherein the instructions, when executed, cause the method provided in the other aspect of the above embodiments.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

The present disclosure further provides a readable storage medium on which instructions are stored. When the instructions are executed by a computer, the functions of any of the above method embodiments are implemented.

The present disclosure further provides a computer program product, which, when been executed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD) or the like.

Those of ordinary skill in the art can understand that the first, second, and other numerical numbers involved in the present disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for supporting a multi-Physical Random Access Channel (PRACH) transmission configuration across Synchronization Signal Blocks (SSBs), performed by a network side device, and comprising:
sending a multi-PRACH transmission configuration to a terminal device, wherein the multi-PRACH transmission configuration is configured to indicate a SSB usage mode corresponding to a PRACH resource used by the terminal device to send, according to the multi-PRACH transmission configuration, a plurality of PRACH transmissions; and
receiving a plurality of PRACHs which are transmitted on the PRACH resource by the terminal device through the SSB usage mode.

2. The method according to claim 1, wherein sending the multi-PRACH transmission configuration to the terminal device comprises:
sending a multi-PRACH transmission mode configuration to the terminal device.

3. The method according to claim 2, wherein sending the multi-PRACH transmission mode configuration to the terminal device comprises at least one of:
sending a first multi-PRACH transmission mode configuration to the terminal device, wherein the first multi-PRACH transmission mode configuration is that SSBs corresponding to the PRACH resource are the same; or
sending a second multi-PRACH transmission mode configuration to the terminal device, wherein the second multi-PRACH transmission mode configuration is that SSBs corresponding to the PRACH resource are different.

4. The method according to claim 3, wherein sending the first multi-PRACH transmission mode configuration to the terminal device comprises at least one of:
sending to the terminal device a first multi-PRACH transmission mode configuration in which cross-SSB is allowed; or
sending to the terminal device a first multi-PRACH transmission mode configuration in which the cross-SSB is not allowed; and
wherein sending the second multi-PRACH transmission mode configuration to the terminal device comprises at least one of:
sending to the terminal device a second multi-PRACH transmission mode configuration in which an SSB gap between PRACH transmissions is allowed; or
sending to the terminal device a second multi-PRACH transmission mode configuration in which the SSB gap between the PRACH transmissions is not allowed.

5. (canceled)

6. The method according to claim 1, wherein sending the multi-PRACH transmission configuration to the terminal device comprises:
sending the multi-PRACH transmission configuration to the terminal device, wherein the multi-PRACH transmission configuration comprises a first multi-PRACH transmission configuration based on a Contention-Free Random Access (CFRA) and a second multi-PRACH transmission configuration based on a Contention-Based Random Access (CBRA); and
wherein a trigger mode of the CFRA comprises at least one of:
a Physical Downlink Control Channel (PDCCH) trigger mode;
a handover trigger mode;
a beam failure recovery trigger mode; or
a PScell addition or change trigger mode.

7. (canceled)

8. The method according to claim 6, wherein sending the multi-PRACH transmission configuration to the terminal device comprises one of:
in response to a CFRA triggered by a PDCCH, sending a PDCCH order to the terminal device, wherein the first multi-PRACH transmission configuration is carried in the PDCCH order;
in response to a CFRA triggered by Pscell addition or change, sending RACH-ConfigDedicated to the terminal device, wherein the first multi-PRACH transmission configuration is carried in a CERA configuration of the RACH-ConfigDedicated;
in response to a CFRA triggered by a handover, sending RACH-ConfigDedicated to the terminal device, wherein the first multi-PRACH transmission configuration is carried in a CFRA configuration of the RACH-ConfigDedicated; or
in response to a CFRA triggered by a beam failure recovery, sending BeamFailureRecoveryConfig to the terminal device, wherein the first multi-PRACH transmission configuration is carried in the BeamFailureRecoveryConfig.

9-11. (canceled)

12. The method according to claim 6, wherein sending the multi-PRACH transmission configuration to the terminal device comprises;
sending the second multi-PRACH transmission configuration to the terminal device through a broadcast signaling or through a dedicated signaling;
wherein the broadcast signaling comprises S stem Message Block 1 (SIB1); and
wherein the dedicated signaling comprises at least one of:
a Radio Resource Control (RRC) Reconfiguration message;
a RRCResume message;
a RRCRelease message; or
a RRCSetup message.

13-14. (canceled)

15. The method according to claim 12, wherein sending the multi-PRACH transmission configuration to the terminal device comprises:
sending a common Random Access Channel (RACH) configuration to the terminal device, wherein the second multi-PRACH transmission configuration is carried in the RACH configuration; and
the RACH configuration comprises common RACH resources separately configured on individual Bandwidth Parts (BWPs).

16. (canceled)

17. The method according to claim 15, wherein sending the RACH configuration to the terminal device comprises one of:
sending first RACH-ConfigCommon in an initial BWP configuration of SIB1 to the terminal device, wherein the RACH configuration is carried in the first RACH-ConfigCommon; or
sending second RACH-ConfigCommon of a BWP configuration of the RRCReconfiguration message to the terminal device, wherein the RACH configuration is carried in the second RACH-ConfigCommon.

18. (canceled)

19. The method according to claim 12, wherein sending the multi-PRACH transmission configuration to the terminal device comprises:
sending a dedicated RACH configuration to the terminal device, wherein the second multi-PRACH transmission configuration is carried in the dedicated RACH configuration.

20. The method according to claim 19, wherein sending the dedicated RACH configuration to the terminal device comprises one of:
in response to a CBRA triggered by a beam failure recovery, sending BeamFailureRecoveryConfig to the terminal device, wherein the second multi-PRACH transmission configuration configured in the dedicated RACH configuration is carried in the BeamFailureRecoveryConfig;
in response to a CBRA triggered by Pscell addition or change, sending RACH-ConfigDedicated to the terminal device, wherein the second multi-PRACH transmission configuration configured in the dedicated RACH configuration is carried in the RACH-ConfigDedicated; or
in response to a CBRA triggered by a handover, sending RACH-ConfigDedicated to the terminal device, wherein the second multi-PRACH transmission configuration configured in the dedicated RACH configuration is carried in the RACH-ConfigDedicated.

21-22. (canceled)

23. The method according to claim 12, wherein sending the multi-PRACH transmission configuration to the terminal device comprises:
sending a RACH configuration of a feature combination to the terminal device, wherein the second multi-PRACH transmission configuration is carried in the RACH configuration of the feature combination; and
wherein the feature combination comprises a Coverage Enhancement feature, and the Coverage Enhancement feature is configured to indicate a Coverage Enhancement feature that supports a second multi-PRACH transmission.

24. (canceled)

25. The method according to claim 1, further comprising:
receiving PRACH capability information sent by the terminal device, wherein the PRACH capability information is configured to indicate capability information of the terminal device supporting multi-PRACH transmission; and
wherein receiving the PRACH capability information sent by the terminal device comprises:
receiving UECapabilityInformation sent by the terminal device, wherein the PRACH capability information is carried in the UECapabilityinformation.

26. (canceled)

27. The method according to claim 25, wherein the PRACH capability information comprises at least one of:
PRACH capability information supporting sending of the multi-PRACH transmission on PRACH resources corresponding to the same beam;
PRACH capability information supporting sending of the multi-PRACH transmission on PRACH resources corresponding to different beams;
PRACH capability information supporting the multi-PRACH transmission cross the SSBs; or
PRACH capability information supporting multi-PRACH transmission cross SSB gaps.

28. The method according to claim 25, wherein the method further comprises;
based on the PRACH capability information, configuring a multi-PRACH transmission mode configuration for the terminal device through a dedicated signaling.

29. A method for supporting a multi-PRACH transmission configuration across SSBs, performed by a terminal device, and comprising:
transmitting to a network side device a plurality of PRACHs on a PRACH resource through a SSB usage mode.

30. The method according to claim 29, wherein transmitting to the network side device the plurality of PRACHs on the PRACH resource through the SSB usage mode comprises at least one of:
transmitting to the network side device the plurality of PRACHs on a PRACH resource corresponding to a first multi-PRACH transmission mode configuration, wherein the first multi-PRACH transmission mode configuration is that SSBs corresponding to the PRACH resource used for the multi-PRACH transmission are the same; or
transmitting to the network side device the plurality of PRACHs on a PRACH resource corresponding to a second multi-PRACH transmission mode configuration, wherein the second multi-PRACH transmission mode configuration is that time domain Random access Occasion (RO) resources used by the multi-PRACH transmission belong to the same SSB or different SSBs.

31. The method according to claim 30, wherein transmitting to the network side device the plurality of PRACHs on the PRACH resource corresponding to the first multi-PRACH transmission mode configuration comprises at least one of:
according to the first multi-PRACH transmission mode configuration, transmitting to the network side device the plurality of PRACHs through a PRACH resource corresponding to a first multi-PRACH transmission in which across-SSB is allowed; or
according to the first multi-PRACH transmission mode configuration, transmitting to the network side device the plurality of PRACHs through a PRACH resource corresponding to a first multi-PRACH transmission in which the across-SSB is not allowed; and
wherein transmitting to the network side device the plurality of PRACHs on the PRACH resource corresponding to the second multi-PRACH transmission mode configuration comprises at least one of:
according to the second multi-PRACH transmission mode configuration, transmitting to the network side device the plurality of PRACHs on a PRACH resource corresponding to a second multi-PRACH transmission in which a SSB gap between PRACH transmissions is allowed; or
according to the second multi-PRACH transmission mode configuration, transmitting to the network side device the plurality of PRACHs on a PRACH resource corresponding to a second multi-PRACH transmission in which the SSB gap between the PRACH transmissions is not allowed.

32-39. (canceled)

40. A network side device, comprising a processor and a memory, wherein a computer program is stored in the memory, and the processor executes the computer program stored in the memory to cause the communication device to execute the following operations:
sending a multi-PRACH transmission configuration to a terminal device, wherein the multi-PRACH transmission configuration is configured to indicate a SSB usage mode corresponding to a PRACH resource used by the terminal device to send, according to the multi-PRACH transmission configuration, a plurality of PRACH transmissions; and
receiving a plurality of PRACHs which are transmitted on the PRACH resource by the terminal device through the SSB usage mode.

41. A terminal device, comprising a processor and a memory, wherein a computer program is stored in the memory, and the processor executes the computer program stored in the memory to cause the communication device to execute the method according to claim 29.

42-45. (canceled)
